(19) United States
(12) Patent Application Publication
(10) Pub. No.: US 2026/0118642 A1
(43) Pub. Date: Apr. 30, 2026

(54) VISUAL SYSTEM

(71) Applicant: ZHEJIANG SUNNY OPTICS CO., LTD., Yuyao City (CN)

(72) Inventors: Biran Chen, Yuyao City (CN); Xiaobin ZHANG, Yuyao City (CN); Lin HUANG, Yuyao City (CN)

(73) Assignee: ZHEJIANG SUNNY OPTICS CO., LTD., Yuyao City (CN)

(21) Appl. No.: 19/252,644

(22) Filed: Jun. 27, 2025

(30) Foreign Application Priority Data
Oct. 30, 2024 (CN) 202411536840.X

(51) Int. Cl. G02B 13/00; G02B 5/30; G02B 9/34; G02B 17/08; G02B 27/01; G02B 27/28

(52) U.S. Cl. CPC G02B 13/0055; G02B 5/3083; G02B 9/34; G02B 13/0045; G02B 17/08; G02B 27/0101; G02B 27/288; G02B 2027/011

(57) ABSTRACT

The disclosure provides a visual system, sequentially including, from a first side to a second side along an optical axis: a first lens with a positive refractive power, a second lens, a third lens, a partially-reflective element, a fourth lens with a negative refractive power, a second quarter-wave plate and a polarizing filter. The visual system further includes a reflective polarizing element and a first quarter-wave plate attached to each other; an included angle β_{1.0} between the optical axis and a tangent of a second side surface of the third lens at a position of an intersection point of a chief ray in a 1.0 field of view after being reflected by the partially-reflective element and the second side surface of the third lens satisfies: 80.5°<β_{1.0}<83.2°.

### CROSS-REFERENCE TO RELATED APPLICATION

The disclosure claims the priority to Chinese Patent Application No. 202411536840.X, filed with the China National Intellectual Property Administration (CNIPA) on Oct. 30, 2024, which is hereby incorporated by reference in its entirety.

### TECHNICAL FIELD

The disclosure relates to the technical field of optical devices, and in particular to a visual system.

### BACKGROUND

Visual systems of virtual reality devices are mainly divided into three types: a visual system using aspheric lenses, a visual system using Fresnel lenses, and a refraction and reflection visual system. Among these, the refraction and reflection visual system represents a significant innovation in visual systems, reserves space for the overall design of the virtual reality device, and has become a mainstream trend in research and development.

The refraction and reflection visual system shortens a body length of the visual system by folding the optical path, such that a center of gravity of the virtual reality device moves backwards, thereby improving the user experience. However, the refraction and reflection visual system often has a serious ghosting problem, affecting an imaging effect of the visual system.

### SUMMARY

Some embodiments of the disclosure provide a visual system, sequentially including from a first side to a second side along an optical axis: a first lens with a positive refractive power, a second lens with a positive or negative refractive power, a third lens with a positive or negative refractive power, a partially-reflective element, a fourth lens with a negative refractive power, a second quarter-wave plate, and a polarizing filter. A first side surface of the first lens is a convex surface. A second side surface of the third lens is a convex surface. A first side surface of the fourth lens is a concave surface. The partially-reflective element is located on the second side surface of the third lens. The visual system includes four lenses with refractive powers. The visual system further includes a reflective polarizing element and a first quarter-wave plate which are arranged in sequence from the first side to the second side and attached to each other, the first quarter-wave plate is located on a first side surface of the second lens, or the reflective polarizing element is located on a second side surface of the second lens. The visual system satisfies: 80.5°<β_{1.0}<83.2° and 81.85°<β_{0.8}<83.85°, wherein β_{1.0} is an included angle between the optical axis and a tangent of the second side surface of the third lens at a position of an intersection point of a chief ray in a 1.0 field of view after being reflected by the partially-reflective element and the second side surface of the third lens, and β_{0.8} is an included angle between the optical axis and a tangent of the second side surface of the third lens at a position of an intersection point of a chief ray in a 0.8 field of view after being reflected by the partially-reflective element and the second side surface of the third lens.

In some embodiments, the visual system further satisfies: −92.1 mm<R6<−68.25 mm, wherein R6 is a radius of curvature of the second side surface of the third lens.

In some embodiments, the visual system further satisfies: −2.2<f3/fz<3.5, wherein f3 is an effective focal length of the third lens, and fz is a combined focal length of the second lens, the reflective polarizing element and the first quarter-wave plate.

In some embodiments, the visual system further satisfies: 3.0<CT4/(CTQ2+CTL)<3.85, wherein CT4 is a center thickness of the fourth lens on the optical axis, CTQ2 is a center thickness of the second quarter-wave plate on the optical axis, and CTL is a center thickness of the polarizing filter on the optical axis.

In some embodiments, the visual system further satisfies: 1.7<R1/f<3.7, wherein R1 is a radius of curvature of the first side surface of the first lens, and f is a total effective focal length of the visual system.

In some embodiments, the visual system further satisfies: −1.9<f4/f1<−0.8, wherein f4 is an effective focal length of the fourth lens, and f1 is an effective focal length of the first lens.

In some embodiments, the visual system further satisfies: 0.3<tan(β_{0.3})/tan(β_{0.1})<0.4, wherein β_{0.3} is an included angle between the optical axis and a tangent of the second side surface of the third lens at a position of an intersection point of a chief ray in a 0.3 field of view after being reflected by the partially-reflective element and the second side surface of the third lens, and β_{0.1} is an included angle between the optical axis and a tangent of the second side surface of the third lens at a position of an intersection point of a chief ray in a 0.1 field of view after being reflected by the partially-reflective element and the second side surface of the third lens.

In some embodiments, the visual system further satisfies: 168.15°<β_{0.5}+β_{0.6}<170.35°, wherein β_{0.8} is an included angle between the optical axis and a tangent of the second side surface of the third lens at a position of an intersection point of a chief ray in a 0.5 field of view after being reflected by the partially-reflective element and the second side surface of the third lens, and β_{0.6} is an included angle between the optical axis and a tangent of the second side surface of the third lens at a position of an intersection point of a chief ray in a 0.6 field of view after being reflected by the partially-reflective element and the second side surface of the third lens.

In some embodiments, the visual system further satisfies: 17.2 mm<f×(N3/N1)<21.8 mm, wherein f is a total effective focal length of the visual system, N1 is a refractive index of the first lens, and N3 is a refractive index of the third lens.

In some embodiments, the visual system further satisfies: 0.05<TD/|f4|<0.25, wherein TD is an on-axis distance from the first side surface of the first lens to a second side surface of the fourth lens, and f4 is an effective focal length of the fourth lens.

In some embodiments, the visual system further satisfies: 0.08<(CTR+CTQ1)/T12<0.25, wherein T12 is an on-axis distance from a second side surface of the first lens to the first side surface of the second lens, CTR is a center thickness of the reflective polarizing element on the optical axis, and CTQ1 is a center thickness of the first quarter-wave plate on the optical axis.

In some embodiments, the visual system further satisfies: 81.2°<β_{0.9}<83.5°, wherein β_{0.9} is an included angle between the optical axis and a tangent of the second side surface of the third lens at a position of an intersection point of a chief ray in a 0.9 field of view after being reflected by the partially-reflective element and the second side surface of the third lens.

In some embodiments, the visual system further satisfies: 21.5<Vmin<24.0, wherein Vmin is an Abbe number of a lens with a minimum Abbe number among the first lens to the fourth lens.

In some embodiments, the visual system further satisfies: 0.45<R7/R6<1.55, wherein R6 is a radius of curvature of the second side surface of the third lens, and R7 is a radius of curvature of the first side surface of the fourth lens.

The position of the intersection point of the chief ray in the 1.0 field of view after being reflected by the partially-reflective element and the second side surface of the third lens is A_{1.0}, and the position of the intersection point of the chief ray in the 0.8 field of view after being reflected by the partially-reflective element and the second side surface of the third lens is A_{0.8}. In the disclosure, by controlling the included angle between the optical axis and the tangent of the second side surface of the third lens at the position of the intersection point A_{1.0}, and the included angle between the optical axis and the tangent of the second side surface of the third lens at the position of the intersection point A_{0.8}, a slope of tangents of the partially-reflective element at the position of the intersection points A_{1.0} and A_{0.8} is able to be constrained, such that light rays pass through the first quarter-wave plate and the reflective polarizing element in a manner of approaching parallel light in a refraction and reflection process, reducing a polarization angle effect, thereby reducing a ghost image caused by light rays directly passing through the reflective polarizing element.

### BRIEF DESCRIPTION OF THE DRAWINGS

Other features, objects, and advantages of the disclosure will become more apparent upon reading the detailed description of non-limiting embodiments, which proceeds with reference to the following drawings. In the drawings:

FIG. 1 shows a structural schematic diagram of a visual system according to Embodiment 1 of the disclosure;

FIG. 2 shows a modulation transfer function curve of a visual system according to Embodiment 1 of the disclosure;

FIG. 3 shows a structural schematic diagram of a visual system according to Embodiment 2 of the disclosure;

FIG. 4 shows a modulation transfer function curve of a visual system according to Embodiment 2 of the disclosure;

FIG. 5 shows a structural schematic diagram of a visual system according to Embodiment 3 of the disclosure;

FIG. 6 shows a modulation transfer function curve of a visual system according to Embodiment 3 of the disclosure;

FIG. 7 shows a structural schematic diagram of a visual system according to Embodiment 4 of the disclosure;

FIG. 8 shows a modulation transfer function curve of a visual system according to Embodiment 4 of the disclosure;

FIG. 9 shows a structural schematic diagram of a visual system according to Embodiment 5 of the disclosure;

FIG. 10 shows a modulation transfer function curve of a visual system according to Embodiment 5 of the disclosure;

FIG. 11 shows a structural schematic diagram of a visual system according to Embodiment 6 of the disclosure;

FIG. 12 shows a modulation transfer function curve of a visual system according to Embodiment 6 of the disclosure;

FIG. 13 shows schematic diagrams of β_{1.0}, β_{0.9}, β_{0.8}, β_{0.6}, β_{0.5}, β_{0.3}, and β_{0.1} of a visual system according to an embodiment of the disclosure;

FIG. 14 shows a ghost image effect diagram with a visual system satisfying β_{1.0}=73.5° and β_{0.8}=75°;

FIG. 15 shows a ghost image effect diagram with a visual system satisfying β_{1.0}=84.6° and β_{0.9}=86°;

FIG. 16 shows a ghost image effect diagram with a visual system satisfying β_{1.0}=82.25° and β_{0.8}=82.76°.

### DETAILED DESCRIPTION OF THE EMBODIMENTS

For a better understanding of the disclosure, various aspects of the disclosure will be described in more detail with reference to the drawings. It should be understood that these detailed descriptions are merely illustrative of specific embodiments of the disclosure and are not intended to limit the scope of the disclosure in any way. Like reference signs refer to like elements throughout the description.

It should be noted that, in this description, the expressions such as first and second are only used to distinguish one feature from another feature, and do not represent any limitation to the feature. Thus, a first lens discussed below could also be termed a second lens without departing from the teachings of the disclosure.

In the drawings, the thickness, size and shape of the lenses have been slightly exaggerated for ease of illustration. In particular, the spherical or aspheric shape shown in the drawings is shown by way of example. That is, the spherical or aspheric shape is not limited to the spherical or aspheric shape shown in the drawings. The drawings are by way of example only and not strictly to scale.

Herein, the paraxial region refers to a region near the optical axis. If the lens surface is convex and the convex position is not defined, it indicates that the lens surface is convex at least in the paraxial region; if the lens surface is concave and the concave position is not defined, it indicates that the lens surface is concave at least in the paraxial region. The surface of each lens closest to a first side (e. g., the human eye side) is referred to as a first side surface of the lens, and the surface of each lens closest to a second side (e. g., the display screen side) Is referred to as a second side surface of the lens.

It will be further understood that the terms “include”, “including”, “have”, “contain” and/or “containing” when used in this description, specify the presence of stated features, elements, and/or components, but do not preclude the presence or addition of one or more other features, elements, components, and/or combinations thereof. In addition, when describing the embodiments of the disclosure, “may” is used to mean “one or more embodiments of the disclosure”. Also, the term “exemplary” is intended to mean exemplary or illustrative.

Unless otherwise defined, all the terms, including technical and scientific terms, used herein have the same meaning as commonly understood by one of ordinary skill in the art to which the disclosure belongs. It should also be understood that terms, such as those defined in commonly used dictionaries, should be interpreted as with a meaning that is consistent with their meaning in the context of the relevant art and will not be interpreted in an idealized or overly formal sense unless expressly so defined herein.

It should be noted that the embodiments of the disclosure and the features in the embodiments may be combined with each other without conflict. The disclosure will be described below with reference to the drawings and examples in detail.

The features, principles and other aspects of the disclosure are described in detail below.

Some embodiments of the disclosure provide a visual system, which includes a first lens, a second lens, a third lens, a partially-reflective element, a fourth lens, a second quarter-wave plate, and a polarizing filter which are arranged in sequence from a first side to a second side along an optical axis.

In an embodiment, the first lens has a positive refractive power. A first side surface of the first lens is a convex surface, and a second side surface of the first lens is a convex or concave surface.

In an embodiment, the second lens has a positive or negative refractive power. A first side surface of the second lens is a planar or convex or concave surface, and a second side surface of the second lens is a convex or planar surface.

In an embodiment, the third lens has a positive or negative refractive power. A first side surface of the third lens is a convex or concave surface, and a second side surface of the third lens is a convex surface.

In an embodiment, the fourth lens has a negative refractive power. A first side surface of the fourth lens is a concave surface, and a second side surface of the fourth lens is a planar or convex surface.

In an embodiment, the visual system further includes a reflective polarizing element and a first quarter-wave plate which are arranged in sequence from the first side to the second side. The first quarter-wave plate is configured to change a polarization state of light rays, for example, convert a circularly polarized light into a linearly polarized light, or convert the linearly polarized light into the circularly polarized light. The circularly polarized light includes a right-handed circularly polarized light or a left-handed circularly polarized light. The linearly polarized light includes an S-linearly polarized light or a P-linearly polarized light. The reflective polarizing element is configured to reflect the linearly polarized light in a predetermined direction and transmit the linearly polarized light orthogonal to the predetermined direction. For example, the reflective polarizing element is able to reflect the S-linearly polarized light and transmit the P-linearly polarized light, or the reflective polarizing element is able to reflect the P-linearly polarized light and transmit the S-linearly polarized light.

In an embodiment, the reflective polarizing element and the first quarter-wave plate are attached to each other. The first quarter-wave plate is located on a first side surface of the second lens, or the reflective polarizing element is located on a second side surface of the second lens. For example, the first quarter-wave plate is at least partially attached to the first side surface of the second lens, and the reflective polarizing element is at least partially attached to a first side surface of the first quarter-wave plate. As another example, the reflective polarizing element is at least partially attached to the second side surface of the second lens, and the first quarter-wave plate is at least partially attached to a second side surface of the reflective polarizing element. In an embodiment, a surface of the second lens provided with the reflective polarizing element and the first quarter-wave plate is a planar surface.

In an embodiment, the partially-reflective element is located on and at least partially attached to the second side surface of the third lens. The partially-reflective element has a semi-transmissive and semi-reflective effect on the light rays. By providing the partially-reflective element on the second side surface of the third lens, and combining with the reflective polarizing element and the first quarter-wave plate, the light rays are able to be refracted and reflected for multiple times, thereby effectively reducing the body length of the visual system.

In an embodiment, the second quarter-wave plate and the polarizing filter is attached to each other. The second quarter-wave plate is located on the second side surface of the fourth lens, or the second quarter-wave plate and the polarizing filter are located between the fourth lens and an imaging surface on the second side of the visual system. In an embodiment, a surface of the fourth lens provided with the second quarter-wave plate and the polarizing filter is a planar surface.

In an embodiment, the visual system further includes a diaphragm which is arranged between the first side and the first lens. In an embodiment, the diaphragm is, for example, a user's pupil. An image light from the second side is finally projected to the eyes of the user on the first side after being refracted and reflected for multiple times by the polarizing filter, the second quarter-wave plate, the fourth lens, the partially-reflective element, the third lens, the second lens, the first quarter-wave plate, the reflective polarizing element, the first lens, and so on.

In an embodiment, the first side is, for example, a human eye side, and the second side is, for example, a display screen side. Accordingly, a first side surface of each element (the first lens, the reflective polarizing element, the first quarter-wave plate, the second lens, the third lens, the partially-reflective element, the fourth lens, the second quarter-wave plate and the polarizing filter) is referred to as a side near the human eye, and a second side surface is referred to as a side near display the screen.

In an embodiment, the second side of the visual system is provided with an imaging surface. The imaging surface is provided with a display screen. An image light from the display screen is able to sequentially pass through the polarizing filter, the second quarter-wave plate, the fourth lens, the third lens, the second lens and the first quarter-wave plate, reach the reflective polarizing element, and then be reflected at the reflective polarizing element to form a first reflected image light. The first reflected image light passes through the first quarter-wave plate, the second lens and the third lens, reaches the partially-reflective element on the second side surface of the third lens, and is then reflected at the partially-reflective element to form a second reflected image light. The second reflected image light sequentially passes through the third lens, the second lens, the first quarter-wave plate, the reflective polarizing element and the first lens to the diaphragm, and is finally projected to the user's eyes.

In another embodiment, the image light from the display screen is able to sequentially pass through the polarizing filter, the second quarter-wave plate, the fourth lens, the third lens and the first quarter-wave plate, reach the reflective polarizing element, and then be reflected at the reflective polarizing element to form a first reflected image light. The first reflected image light passes through the first quarter-wave plate and the third lens, reaches the partially-reflective element on the second side surface of the third lens, and then is reflected at the partially-reflective element to form a second reflected image light. The second reflected image light sequentially passes through the third lens, the first quarter-wave plate, the reflective polarizing element, the second lens and the first lens to the diaphragm, and is finally projected to the user's eyes.

The visual system provided in the disclosure folds the required optical path by a combination of light reflection and refraction without affecting the projection quality, thereby effectively shortening the body length of the visual system.

In an embodiment, the visual system satisfies: 80.5°<β_{1.0}<83.2° and 81.85°<β_{0.8}<83.85°, wherein β_{1.0} is an included angle between the optical axis and a tangent of the second side surface of the third lens at a position of an intersection point of a chief ray in a 1.0 field of view after being reflected by the partially-reflective element and the second side surface of the third lens, and β_{0.8} is an included angle between the optical axis and a tangent of the second side surface of the third lens at a position of an intersection point of a chief ray in a 0.8 field of view after being reflected by the partially-reflective element and the second side surface of the third lens. As shown in FIG. 13(a), the position of the intersection point of the chief ray in the 1.0 field of view after being reflected by the partially-reflective element and the second side surface of the third lens is, for example, A_{1.0}, and the included angle between the optical axis and the tangent of the second side surface of the third lens at the position of the intersection point A_{1.0} is, for example, β_{1.0}. As shown in FIG. 13(c), the position of the intersection point of the chief ray in the 0.8 field of view after being reflected by the partially-reflective element and the second side surface of the third lens is, for example, A_{0.8}, and the included angle between the optical axis and the tangent of the second side surface of the third lens at the position of an intersection point A_{0.8} is, for example, β_{0.8}. By controlling the included angle between the optical axis and the tangent of the second side surface of the third lens at the position of the intersection point A_{1.0}, and the included angle between the optical axis and the tangent of the second side surface of the third lens at the position of an intersection point A_{0.8}, a slope of tangents of the partially-reflective element at the position of the intersection points A_{1.0} and A_{0.8} is able to be constrained, such that light rays pass through the first quarter-wave plate and the reflective polarizing element in a manner of approaching parallel light in the refraction and reflection process, reducing the polarization angle effect, thereby reducing a ghost image caused by the light rays directly passing through the reflective polarizing element.

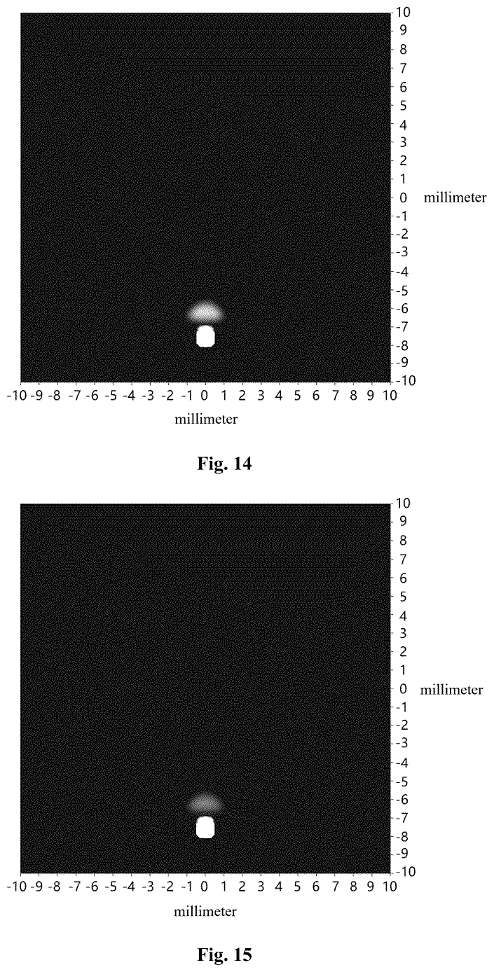

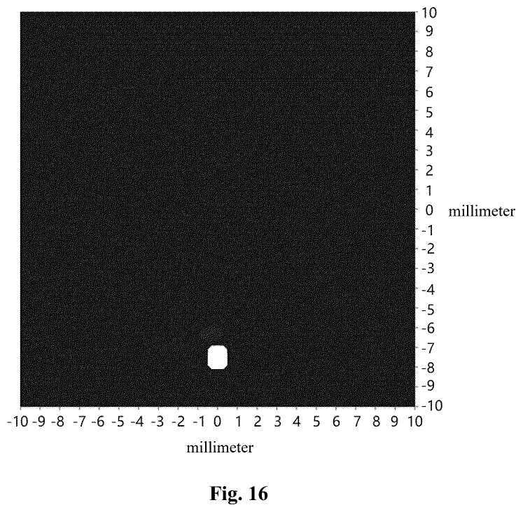

An imaging effect of the visual system will be described below in view of FIGS. 14, 15 and 16. FIG. 14 is a ghost image effect diagram with a visual system satisfying β_{1.0}=73.5° and β_{0.8}=75; FIG. 15 shows a ghost image effect diagram with a visual system satisfying β_{1.0}=84.6° and β_{0.8}=86°; FIG. 16 shows a ghost image effect diagram with a visual system satisfying β_{1.0}=82.25° and β_{0.8}−82.76°.

From FIG. 14, when the visual system satisfies A_{1.0}=73.5° and β_{0.8}=75°, the ghost image in the direct optical path of the visual system is relatively large, and in this case, a ratio of a power of a direct optical path to a power of a main optical path is 3.57%. From FIG. 15, when the visual system satisfies β_{1.0}=84.6° and β_{0.6}=86°, the ghost image in the direct optical path of the visual system is relatively large, and in this case, the ratio of the power of the direct optical path to the power of the main optical path is 1.47%. However, when the visual system satisfies β_{1.0}=82.25° and β_{0.8}=82.76°, the ghost image in the direct optical path of the visual system is obviously reduced (FIG. 16), and in this case, the ratio of the power of the direct optical path to the power of the main optical path is 0.06%. Hence, by controlling the visual system to satisfy “80.5°<β_{1.0}<83.2° and 81.85°<β_{0.6}<83.85°”, the ghost image formed by the light rays directly passing through the reflective polarizing element is able to be reduced. It should be noted that the direct optical path here is an optical path formed by the light rays directly passing through the reflective polarizing element, and the main optical path is an optical path formed by the light rays being reflected twice by the reflective polarizing element and the partially-reflective element.

In an embodiment, the visual system satisfies: −92.1 mm<R6<−68.25 mm, wherein R6 is a radius of curvature of the second side surface of the third lens. By reasonably configuring the radius of curvature of the second side surface of the third lens, a processability of the third lens is able to be improved. Moreover, a curvature of the partially-reflective element on the second side surface of the third lens is able to be controlled. This, in turn, constrains the slope of tangents of the partially-reflective element at positions of intersection points corresponding to the chief ray in different fields of view, such that the reflected light angle of the light rays after being reflected by the partially-reflective element is kept within an appropriate range, thereby reducing the ghost image of the visual system.

In an embodiment, the visual system satisfies: −2.2<f3/fz<3.5, wherein f3 is an effective focal length of the third lens, and fz is a combined focal length of the second lens, the reflective polarizing element and the first quarter-wave plate. By reasonably configuring a ratio of the effective focal length of the third lens to the combined focal length of the second lens, the reflective polarizing element and the first quarter-wave plate, the refractive powers of the second lens and the third lens are able to be distributed, such that when passing through the first quarter-wave plate and the reflective polarizing element for the first time, the light rays are incident onto the two elements at an angle approaching perpendicular, thereby reducing the ghost image of the visual system.

In an embodiment, the visual system satisfies: 3.0<CT4/(CTQ2+CTL)<3.85, wherein CT4 is a center thickness of the fourth lens on the optical axis, CTQ2 is a center thickness of the second quarter-wave plate on the optical axis, and CTL is a center thickness of the polarizing filter on the optical axis. By controlling a relationship among the center thickness of the fourth lens on the optical axis, the center thickness of the second quarter-wave plate on the optical axis, and the center thickness of the polarizing filter on the optical axis, the body length of the visual system is able to be reduced while ensuring the processability of the fourth lens, thereby achieving the lightness and thinness of the visual system.

In an embodiment, the visual system satisfies: 1.7<R1/f<3.7, wherein R1 is a radius of curvature of the first side surface of the first lens, and f is a total effective focal length of the visual system. By reasonably configuring a ratio of the radius of curvature of the first side surface of the first lens to the total effective focal length of the visual system, the first side surface of the first lens is able to better converge the light rays, thereby reducing a sensitivity tolerance of the visual system while satisfying the imaging requirements.

In an embodiment, the visual system satisfies: −1.9<f4/f1<−0.8, wherein f4 is an effective focal length of the fourth lens, and f1 is an effective focal length of the first lens. By reasonably configuring a ratio of the effective focal length of the fourth lens to the effective focal length of the first lens, an emergent angle of the light rays from the display screen after emerging from the fourth lens is able to be small, thereby facilitating a subsequent parallel refraction and reflection of the light rays.

In an embodiment, the visual system satisfies 0.3<tan(β_{0.3})/tan(β_{0.1})<0.4, wherein β_{0.3} is an included angle between the optical axis and a tangent of the second side surface of the third lens at a position of an intersection point of a chief ray in a 0.3 field of view after being reflected by the partially-reflective element and the second side surface of the third lens, and β_{0.1} is an included angle between the optical axis and a tangent of the second side surface of the third lens at a position of an intersection point of a chief ray in a 0.1 field of view after being reflected by the partially-reflective element and the second side surface of the third lens. As shown in FIG. 13(f), the position of the intersection point of the chief ray in the 0.3 field of view after being reflected by the partially-reflective element and the second side surface of the third lens is, for example, A_{0.3}, and the included angle between the optical axis and the tangent of the second side surface of the third lens at the position of the intersection point A_{0.3} is, for example, β_{0.3}. As shown in FIG. 13(g), the position of the intersection point of the chief ray in the 0.1 field of view after being reflected by the partially-reflective element and the second side surface of the third lens is, for example, A_{0.1}, and the included angle between the optical axis and the tangent of the second side surface of the third lens at the position of the intersection point A_{0.1} is, for example, β_{0.1}. By controlling the described conditional expression, the slope of the tangent of the second side surface of the third lens at the position of the intersection point A_{0.3} is able to be made less than the slope of the tangent of the second side surface of the third lens at the position of the intersection point A_{0.1}, thereby improving the processability of the third lens while ensuring the imaging quality of the visual system.

In an embodiment, the visual system satisfies: 168.15°<β₀.5+β_{0.6}<170.35°, wherein β_{0.5} is an included angle between the optical axis and a tangent of the second side surface of the third lens at a position of an intersection point of a chief ray in a 0.5 field of view after being reflected by the partially-reflective element and the second side surface of the third lens, and β_{0.8} is an included angle between the optical axis and a tangent of the second side surface of the third lens at a position of an intersection point of a chief ray in a 0.6 field of view after being reflected by the partially-reflective element and the second side surface of the third lens. As shown in FIG. 13(d), the position of the intersection point of the chief ray in the 0.6 field of view after being reflected by the partially-reflective element and the second side surface of the third lens is, for example, A_{0.8}, and the included angle between the optical axis and the tangent of the second side surface of the third lens at the position of the intersection point A_{0.8} is, for example, β_{0.8}. As shown in FIG. 13(e), the position of the intersection point of the chief ray in the 0.5 field of view after being reflected by the partially-reflective element and the second side surface of the third lens is, for example, A_{0.8}, and the included angle between the optical axis and the tangent of the second side surface of the third lens at the position of the intersection point A_{0.8} is, for example, β_{0.8}. By controlling the described conditional expression, the slope of tangents of the second side surface of the third lens at a position of an intersection points A_{0.8} and A_{0.8} is able to be constrained within a reasonable range, such that the reflected light angle when the light rays are refracted and reflected at the two positions of intersection points and in the region between the two positions of intersection points is not too large, thereby facilitating the subsequent parallel refraction and reflection of the light rays, and improving the processability of the third lens.

In an embodiment, the visual system satisfies: 17.2 mm<f×(N3/N1)<21.8 mm, wherein f is a total effective focal length of the visual system, N1 is a refractive index of the first lens, and N3 is a refractive index of the third lens. By controlling a relationship among the total effective focal length of the visual system, the refractive index of the first lens, and the refractive index of the third lens, the imaging performance of the visual system is able to be improved and the material cost of the first lens and the third lens is able to be reduced.

In an embodiment, the visual system satisfies: 0.05<TD/|f4|<0.25, wherein TD is an on-axis distance from the first side surface of the first lens to a second side surface of the fourth lens, and f4 is an effective focal length of the fourth lens. By reasonably configuring a ratio of the distance from the first side surface of the first lens to the second side surface of the fourth lens on the optical axis to the effective focal length of the fourth lens, the body length of the visual system is able to be reduced, thereby achieving the lightness and thinness of the visual system.

In an embodiment, the visual system satisfies: 0.08<(CTR+CTQ1)/T12<0.25, wherein T12 is an on-axis distance from a second side surface of the first lens to the first side surface of the second lens, CTR is a center thickness of the reflective polarizing element on the optical axis, and CTQ1 is a center thickness of the first quarter-wave plate on the optical axis. By controlling the described conditional expression, the distance from the second side surface of the first lens to the first side surface of the second lens on the optical axis is able to be constrained within a reasonable range, such that there is sufficient installation space between the first lens and the second lens, thereby facilitating the assembly of the reflective polarizing element and the first quarter-wave plate, and no interference occurs between the reflective polarizing element and the first quarter-wave plate.

In an embodiment, the visual system satisfies: 81.2°<β_{0.9}<83.5°, wherein β_{0.9} is an included angle between the optical axis and a tangent of the second side surface of the third lens at a position of an intersection point of a chief ray in a 0.9 field of view after being reflected by the partially-reflective element and the second side surface of the third lens. As shown in FIG. 13(b), the position of the intersection point of the chief ray in the 0.9 field of view after being reflected by the partially-reflective element and the second side surface of the third lens is, for example, A_{0.9}, and the included angle between the optical axis and the tangent of the second side surface of the third lens at the position of the intersection point β_{0.9} is, for example, β_{0.9}. By controlling the described conditional expression, the slope of the tangent of the second side surface of the third lens at the position of an intersection point A_{0.8} is able to be constrained within a reasonable range, such that the reflected light angle when the light rays are refracted and reflected at the position of the intersection point and in the region near the position of the intersection point is not too large, thereby facilitating the subsequent parallel refraction and reflection of the light rays, and improving the processability of the third lens.

In an embodiment, the visual system satisfies: 21.5<Vmin<24.0, wherein Vmin is an Abbe number of a lens with a minimum Abbe number among the first lens to the fourth lens.

By reasonably configuring the Abbe number of the first lens to the fourth lens, an imaging chromatic aberration of the visual system is able to be reduced, and the imaging quality of the visual system is able to be improved.

In an embodiment, the visual system satisfies: 0.45<R7/R6<1.55, wherein R6 is a radius of curvature of the second side surface of the third lens, and R7 is a radius of curvature of the first side surface of the fourth lens. By reasonably configuring a ratio of the radius of curvature of the first side surface of the fourth lens to the radius of curvature of the second side surface of the third lens, an angle change of the light rays when passing through the two surfaces is able to be kept within a certain range, thereby improving a relative illuminance of the light rays in a large field of view of the visual system.

The visual system according to the described embodiments of the disclosure is able to adopt a plurality of lenses such as the four lenses described above. By reasonably distributing parameters of the reflective polarizing element, the first quarter-wave plate, the second quarter-wave plate, the polarizing filter and the lenses, the body length of the visual system is able to be reduced, and the imaging quality of the visual system is able to be improved. The visual system configured as above has the characteristics of lightness and thinness, good imaging quality, etc., and is able to well satisfy the usage requirements of various portable electronic products in a projection scenario.

In the embodiments of the disclosure, at least one of surfaces of the first lens, the second lens, the third lens, and the fourth lens is an aspheric surface. The aspheric lens is characterized by a curvature that varies continuously from the center of the lens to the periphery of the lens. Unlike a spherical lens having a constant curvature from the center of the lens to the periphery of the lens, the aspheric lens has better radius of curvature characteristics, and has advantages of correcting distortion aberration and astigmatic aberration. Upon using the aspheric lens, the aberration occurring during imaging is able to be eliminated as much as possible, thereby improving the imaging quality.

Some other embodiments of the disclosure provide a visual system, including sequentially from a first side to a second side along an optical axis: a first lens with a positive refractive power, a second lens with a positive or negative refractive power, a third lens with a positive or negative refractive power, a partially-reflective element, a fourth lens with a negative refractive power, a second quarter-wave plate, and a polarizing filter. A first side surface of the first lens is a convex surface. A second side surface of the third lens is a convex surface. A first side surface of the fourth lens is a concave surface. The partially-reflective element is located on the second side surface of the third lens. The visual system includes four lenses with refractive powers. The visual system further includes a reflective polarizing element and a first quarter-wave plate which are arranged in sequence from the first side to the second side and attached to each other, wherein the first quarter-wave plate is located on a first side surface of the second lens, or the reflective polarizing element is located on a second side surface of the second lens.

The visual system satisfies: 80.5°<β_{1.0}<83.2° and −92.1 mm<R6<−68.25 mm, wherein β_{1.0} is an included angle between the optical axis and a tangent of the second side surface of the third lens at a position of an intersection point of a chief ray in a 1.0 field of view after being reflected by the partially-reflective element and the second side surface of the third lens, and R6 is a radius of curvature of the second side surface of the third lens. As shown in FIG. 13(a), the position of the intersection point of the chief ray in a 1.0 field of view after being reflected by the partially-reflective element and the second side surface of the third lens is, for example, A_{1.0}, and the included angle between the optical axis and the tangent of the second side surface of the third lens at the position of an intersection point A_{1.0} is, for example, β_{1.0}. By controlling the included angle between the optical axis and the tangent of the second side surface of the third lens at the position of the intersection point A_{1.0}, and the radius of curvature of the second side surface of the third lens, the slope of tangents of the partially-reflective element at positions of intersection points corresponding to the chief ray in different fields of view is able to be constrained while ensuring the processability of the third lens, such that the reflected light angle of the light rays after being reflected by the partially-reflective element is kept within an appropriate range, and the light rays pass through the first quarter-wave plate and the reflective polarizing element in a manner of approaching parallel light in the refraction and reflection process, reducing the polarization angle effect, thereby reducing the ghost image caused by the light rays directly passing through the reflective polarizing element.

However, it will be appreciated by those skilled in the art that the various results and advantages described in this description can be obtained by varying the number of lenses that make up the visual system without departing from the claimed technical solutions.

Specific embodiments of the visual system applicable to the described embodiments are further described below with reference to the drawings.

### Embodiment 1

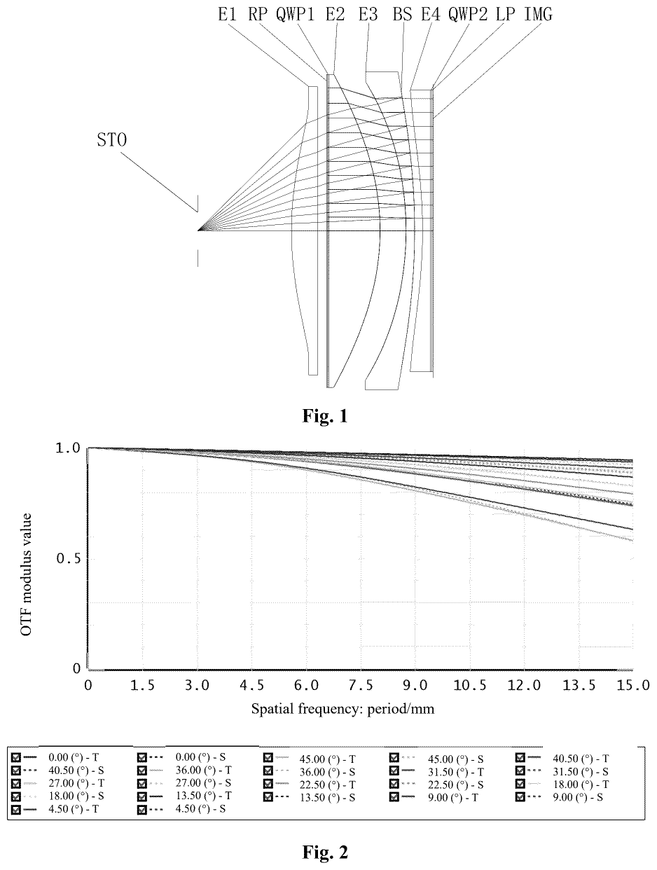

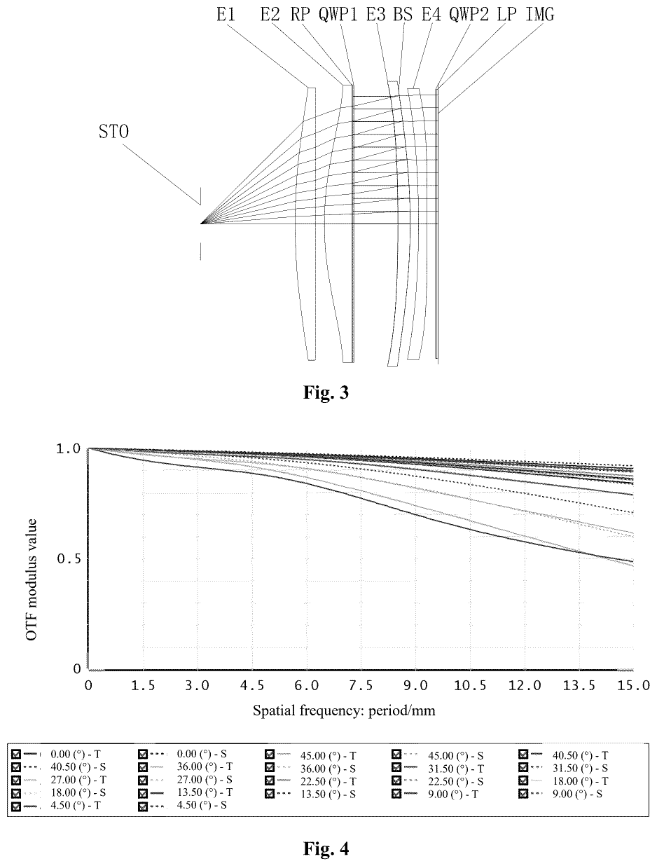

The following describes a visual system according to Embodiment 1 of the disclosure with reference to FIGS. 1-2. FIG. 1 shows a structural schematic diagram of a visual system according to Embodiment 1. FIG. 2 shows a modulation transfer function curve of a visual system according to Embodiment 1, wherein OTF in FIG. 2 refers to optical transfer function. Further, “T” in FIG. 2 represents “Tangential”, and “S” represents “Sagittal”, the same as FIGS. 4, 6, 8, 10 and 12.

As shown in FIG. 1, the visual system includes a first lens E1, a reflective polarizing element RP, a first quarter-wave plate QWP1, a second lens E2, a third lens E3. a partially-reflective element BS, a fourth lens E4, a second quarter-wave plate QWP2, and a polarizing filter LP which are arranged in sequence along an optical axis from a first side to a second side. A diaphragm STO is located at an object side of the first lens E1. In the embodiment, the first side refers to a human eye side, and the second side refers to a display screen side.

The first lens E1 has a positive refractive power, a first side surface S1 of the first lens E1 is a convex surface, and a second side surface S2 of the first lens E1 is a concave surface. The second lens E2 has a positive refractive power, a first side surface S3 of the second lens E2 is a planar surface, and a second side surface S4 of the second lens E2 is a convex surface. The third lens E3 has a negative refractive power, a first side surface S5 of the third lens E3 is a concave surface, and a second side surface S6 of the third lens E3 is a convex surface. The fourth lens E4 has a negative refractive power, a first side surface S7 of the fourth lens E4 is a concave surface, and a second side surface S8 of the fourth lens E4 is a planar surface. The reflective polarizing element RP and the first quarter-wave plate QWP1 are attached to the first side surface S3 of the second lens E2. The partially-reflective element BS is attached to the second side surface S6 of the third lens E3. The second quarter-wave plate QWP2 and the polarizing filter LP are attached to the second side surface S8 of the fourth lens E4. It should be noted that surfaces S1, S2, S3, S4, S5, S6, S7, and S8 are not shown in FIG. 1.

In the embodiment, the second side of the visual system is provided with an imaging surface IMG, which is provided with a display screen. After the image light from the imaging surface IMG sequentially passes through the polarizing filter LP, the second quarter-wave plate QWP2, the fourth lens E4, the third lens E3, the second lens E2 and the first quarter-wave plate QWP1, and reaches the reflective polarizing element RP, a first reflection occurs at the reflective polarizing element RP. After the first reflected light passes through the first quarter-wave plate QWP1, the second lens E2 and the third lens E3, and reaches the partially-reflective element BS located on the second side surface of the third lens, a second reflection occurs at the partially-reflective element BS. The second reflected light sequentially passes through the third lens E3, the second lens E2, the first quarter-wave plate QWP1, the reflective polarizing element RP and the first lens E1 to the diaphragm, and is finally projected to the user's eyes. For example, the light rays reflected twice by the visual system are finally projected to the user's eyes.

Table 1 is a basic parameter table of the visual system according to Embodiment 1, wherein the units of radius of curvature and thickness/distance are all millimeters (mm). The image light from the imaging surface IMG passes through the elements in sequence from number 21 to number 1, and is finally projected to the user's eyes.

TABLE 1

| | | | | | Material | | | |
|---|---|---|---|---|---|---|---|---|
| | | Surface | Radius of | Thickness/ | Refractive | Abbe | Refraction/ | Conic |
| Number | Element | type | Curvature | distance | index | number | reflection | coefficient |
| | | spherical | infinite | −1300.0000 | | | refraction | |
| 1 | diaphragm | spherical | infinite | 10.0000 | | | refraction | |
| 2 | first lens | aspheric | 34.3733 | 2.7860 | 1.547 | 56.14 | refraction | −1.3160 |
| 3 | | thin | 184.5617 | 0.9684 | | | refraction | 98.9989 |
| | | Fresnel | | | | | | |
| 4 | reflective | spherical | infinite | 0.1100 | 1.503 | 57.00 | refraction | |
| | polarizing | | | | | | | |
| | element | | | | | | | |
| 5 | first | spherical | infinite | 0.1100 | 1.503 | 57.00 | refraction | |
| | quarter- | | | | | | | |
| | wave plate | | | | | | | |
| 6 | second lens | spherical | infinite | 5.4869 | 1.547 | 56.14 | refraction | |
| 7 | | aspheric | −26.0525 | 2.7673 | | | refraction | −2.0776 |
| 8 | third lens | aspheric | −34.3386 | 0.9166 | 1.644 | 23.98 | refraction | −6.0727 |
| 9 | partially- | aspheric | −73.5326 | −0.9166 | 1.644 | 23.98 | reflection | 12.4901 |
| | reflective | | | | | | | |
| | element | | | | | | | |
| 10 | | aspheric | −34.3386 | −2.7673 | | | refraction | −6.0727 |
| 11 | | aspheric | −26.0525 | −5.4869 | 1.547 | 56.14 | refraction | −2.0776 |
| 12 | | spherical | infinite | −0.1100 | 1.503 | 57.00 | refraction | |
| 13 | reflective | spherical | infinite | 0.1100 | 1.503 | 57.00 | reflection | |
| | polarizing | | | | | | | |
| | element | | | | | | | |
| 14 | second lens | spherical | infinite | 5.4869 | 1.547 | 56.14 | refraction | |
| 15 | | aspheric | −26.0525 | 2.7673 | | | refraction | −2.0776 |
| 16 | third lens | aspheric | −34.3386 | 0.9166 | 1.644 | 23.98 | refraction | −6.0727 |
| 17 | | aspheric | −73.5326 | 0.8449 | | | refraction | 12.4901 |
| 18 | fourth lens | aspheric | −55.6695 | 0.8609 | 1.644 | 23.98 | refraction | 9.3825 |
| 19 | second | spherical | infinite | 0.1100 | 1.503 | 57.00 | refraction | |
| | quarter- | | | | | | | |
| | wave plate | | | | | | | |
| 20 | polarizing | spherical | infinite | 0.1500 | 1.503 | 57.00 | refraction | |
| | filter | | | | | | | |
| 21 | | spherical | infinite | 0.0000 | | | refraction | |
| | imaging | spherical | infinite | 0.0000 | | | refraction | |
| | surface | | | | | | | |

In the embodiment, the first side surface S1 of the first lens E1, the second side surface S4 of the second lens E2, the first side surface S5 and the second side surface S6 of the third lens E3, and the first side surface S7 of the fourth lens E4 are aspheric surfaces, the second side surface S2 of the first lens E1 is a thin Fresnel surface, and the surface type of each aspheric surface or thin Fresnel surface may be defined by, but not limited to, the following formula:

$$x = \frac{{ch}^{2}}{1 + \sqrt{1 - k + 1 ) {c}^{2} {h}^{2}}} + \sum A \text{?} \qquad ( 1 )$$

$$\text{?} \text{indicates text missing or illegible when filed}$$

wherein x is a vector height of a distance between the aspheric surface (or the thin Fresnel surface) and a vertex of the aspheric surface (or the thin Fresnel surface) when the aspheric surface (or the thin Fresnel surface) is located at a position with the height h in an optical axis direction: c is a paraxial curvature of the aspheric surface (or the thin Fresnel surface), c=1/R (i.e., the paraxial curvature c is a reciprocal of the radius of curvature R in Table 1 above); k is a conic coefficient; Ai is an i-th order correction coefficient of the aspheric surface (or the thin Fresnel surface). Table 2 provides the high-order term coefficients A4, A6, A8, A10, A12, A14, A16, A18 and A20 of the surfaces S1, S2, S4, S5, S6 and S7 applicable to Embodiment 1.

TABLE 2

| Surface | | | | | | | | | |
|---|---|---|---|---|---|---|---|---|---|
| Number | A4 | A6 | A8 | A10 | A12 | A14 | A16 | A18 | A20 |
| S1 | −2.9124E−05 | 9.6886E−08 | −4.0238E−11 | −1.7257E−12 | 0.0000E+00 | 0.0000E+00 | 0.0000E+00 | 0.0000E+00 | 0.0000E+00 |
| S2 | −4.7713E−05 | −1.1797E−07 | 1.3744E−09 | −5.4518E−12 | 0.0000E+00 | 0.0000E+00 | 0.0000E+00 | 0.0000E+00 | 0.0000E+00 |
| S4 | 0.0000E+00 | 0.0000E+00 | 0.0000E+00 | 0.0000E+00 | 0.0000E+00 | 0.0000E+00 | 0.0000E+00 | 0.0000E+00 | 0.0000E+00 |
| S5 | −2.2544E−05 | 1.4309E−08 | 0.0000E+00 | 0.0000E+00 | 0.0000E+00 | 0.0000E+00 | 0.0000E+00 | 0.0000E+00 | 0.0000E+00 |
| S6 | 3.0387E−06 | 2.2672E−08 | 0.0000E+00 | 0.0000E+00 | 0.0000E+00 | 0.0000E+00 | 0.0000E+00 | 0.0000E+00 | 0.0000E+00 |
| S7 | 1.6813E−05 | 4.8840E−08 | 0.0000E+00 | 0.0000E+00 | 0.0000E+00 | 0.0000E+00 | 0.0000E+00 | 0.0000E+00 | 0.0000E+00 |

### Embodiment 2

The following describes a visual system according to Embodiment 2 of the disclosure with reference to FIGS. 3-4. FIG. 3 shows a structural schematic diagram of a visual system according to Embodiment 2. FIG. 4 shows a modulation transfer function curve of a visual system according to Embodiment 2, wherein OTF in FIG. 4 refers to optical transfer function.

As shown in FIG. 3, the visual system includes a first lens E1, a second lens E2, a reflective polarizing element RP, a first quarter-wave plate QWP1, a third lens E3, a partially-reflective element BS, a fourth lens E4, a second quarter-wave plate QWP2, and a polarizing filter LP which are arranged in sequence along an optical axis from a first side to a second side. A diaphragm STO is located at an object side of the first lens E1. In the embodiment, the first side refers to a human eye side, and the second side refers to a display screen side.

The first lens E1 has a positive refractive power, a first side surface S1 of the first lens E1 is a convex surface, and a second side surface S2 of the first lens E1 is a concave surface. The second lens E2 has a positive refractive power, a first side surface S3 of the second lens E2 is a convex surface, and a second side surface S4 of the second lens E2 is a planar surface. The third lens E3 has a positive refractive power, a first side surface S5 of the third lens E3 is a concave surface, and a second side surface S6 of the third lens E3 is a convex surface. The fourth lens E4 has a negative refractive power, a first side surface S7 of the fourth lens E4 is a concave surface, and a second side surface S8 of the fourth lens E4 is a convex surface. The reflective polarizing element RP and the first quarter-wave plate QWP1 are attached to the second side surface S4 of the second lens E2. The partially-reflective element BS is attached to the second side surface S6 of the third lens E3. It should be noted that surfaces S1, S2, S3, S4, S5, S6, S7, and S8 are not shown in FIG. 3.

In the embodiment, the second side of the visual system is provided with an imaging surface IMG, which is provided with a display screen. After the image light from the imaging surface IMG sequentially passes through the polarizing filter LP, the second quarter-wave plate QWP2, the fourth lens E4, the third lens E3 and the first quarter-wave plate QWP1, and reaches the reflective polarizing element RP, a first reflection occurs at the reflective polarizing element RP. After the first reflected light passes through the first quarter-wave plate QWM and the third lens E3, and reaches the partially-reflective element BS located on the second side surface of the third lens, a second reflection occurs at the partially-reflective element BS. The second reflected light sequentially passes through the third lens E3, the first quarter-wave plate QWP1, the reflective polarizing element RP, the second lens E2 and the first lens E1 to the diaphragm, and is finally projected to the users eyes. For example, the light rays reflected twice by the visual system are finally projected to the user's eyes.

Table 3 is a basic parameter table of the visual system according to Embodiment 2, wherein the units of radius of curvature and thickness/distance are all millimeters (mm). The image light from the imaging surface IMG passes through the elements in sequence from number 20 to number 1, and is finally projected to the user's eyes.

TABLE 3

| | | | | | Material | | | |
|---|---|---|---|---|---|---|---|---|
| | | Surface | Radius of | Thickness | Refractive | Abbe | Refraction/ | Conic |
| Number | Element | type | curvature | distance | index | number | reflection | coefficient |
| | | spherical | infinite | −1300.0000 | | | refraction | |
| 1 | diaphragm | spherical | infinite | 10.0000 | | | refraction | |
| 2 | first lens | aspheric | 62.9967 | 2.1439 | 1.640 | 23.98 | refraction | −0.9630 |
| 3 | | thin | 121.9472 | 0.9426 | | | refraction | 56.9359 |
| | | Fresnel | | | | | | |
| 4 | second lens | aspheric | 31.4237 | 2.8894 | 1.640 | 23.98 | refraction | −1.0873 |
| 5 | reflective | spherical | infinite | 0.1100 | 1.503 | 57.00 | refraction | |
| | polarizing | | | | | | | |
| | element | | | | | | | |
| 6 | first | spherical | infinite | 0.1100 | 1.503 | 57.00 | refraction | |
| | quarter- | | | | | | | |
| | wave plate | | | | | | | |
| 7 | | spherical | infinite | 4.6608 | | | refraction | |
| 8 | third lens | aspheric | −181.0488 | 1.2884 | 1.640 | 23.98 | refraction | 98.9997 |
| 9 | partially- | aspheric | −68.2589 | −1.2884 | 1.640 | 23.98 | reflection | −1.2033 |
| | reflective | | | | | | | |
| | element | | | | | | | |
| 10 | | aspheric | −181.0488 | −4.6608 | | | refraction | 98.9997 |
| 11 | | spherical | infinite | −0.1100 | 1.503 | 57.00 | refraction | |
| 12 | reflective | spherical | infinite | 0.1100 | 1.503 | 57.00 | reflection | |
| | polarizing | | | | | | | |
| | element | | | | | | | |
| 13 | | spherical | infinite | 4.6608 | | | refraction | |
| 14 | third lens | aspheric | −181.0488 | 1.2884 | 1.640 | 23.98 | refraction | 98.9997 |
| 15 | | aspheric | −68.2589 | 0.8881 | | | refraction | −1.2033 |
| 16 | fourth lens | aspheric | −103.1232 | 0.8984 | 1.640 | 23.98 | refraction | 4.7498 |
| 17 | | aspheric | −1833.2291 | 0.8985 | | | refraction | 18.2168 |
| 18 | second | spherical | infinite | 0.1100 | 1.503 | 57.00 | refraction | |
| | quarter- | | | | | | | |
| | wave plate | | | | | | | |
| 19 | polarizing | spherical | infinite | 0.1500 | 1.503 | 57.00 | refraction | |
| | filter | | | | | | | |
| 20 | | spherical | infinite | 0.0000 | | | refraction | |
| | imaging | spherical | infinite | 0.0000 | | | refraction | |
| | surface | | | | | | | |

In the embodiment, the first side surface S1 of the first lens E1, the first side surface S3 of the second lens E2, the first side surface 85 and the second side surface S6 of the third lens E3, and the first side surface S7 and the second side surface S8 of the fourth lens E4 are aspheric surfaces, and the second side surface 82 of the first lens E1 is a thin Fresnel surface. Table 4 provides the high-order term coefficients A4, A6, A8, A10, A12, A14, A16, A18 and A20 of the surfaces S1. S2, S3, 85, S6, S7 and S8 applicable to Embodiment 2.

TABLE 4

| Surface. | | | | | | | | | |
|---|---|---|---|---|---|---|---|---|---|
| number | A4 | A6 | A8 | A10 | A12 | A14 | A16 | A18 | A20 |
| S1 | −6.1753E−06 | 0.0000E+00 | 0.0000E+00 | 0.0000E+00 | 0.0000E+00 | 0.0000E+00 | 0.0000E+00 | 0.0000E+00 | 0.0000E+00 |
| S2 | −9.6028E−05 | 0.0000E+00 | 0.0000E+00 | 0.0000E+00 | 0.0000E+00 | 0.0000E+00 | 0.0000E+00 | 0.0000E+00 | 0.0000E+00 |
| S3 | −3.0534E−05 | 0.0000E+00 | 0.0000E+00 | 0.0000E+00 | 0.0000E+00 | 0.0000E+00 | 0.0000E+00 | 0.0000E+00 | 0.0000E+00 |
| S5 | −5.7351E−06 | 0.0000E+00 | 0.0000E+00 | 0.0000E+00 | 0.0000E+00 | 0.0000E+00 | 0.0000E+00 | 0.0000E+00 | 0.0000E+00 |
| S6 | 6.1959E−06 | 0.0000E+00 | 0.0000E+00 | 0.0000E+00 | 0.0000E+00 | 0.0000E+00 | 0.0000E+00 | 0.0000E+00 | 0.0000E+00 |
| S7 | −3.2502E−06 | 0.0000E+00 | 0.0000E+00 | 0.0000E+00 | 0.0000E+00 | 0.0000E+00 | 0.0000E+00 | 0.0000E+00 | 0.0000E+00 |
| S8 | −1.8908E−05 | 0.0000E+00 | 0.0000E+00 | 0.0000E+00 | 0.0000E+00 | 0.0000E+00 | 0.0000E+00 | 0.0000E+00 | 0.0000E+00 |

### Embodiment 3

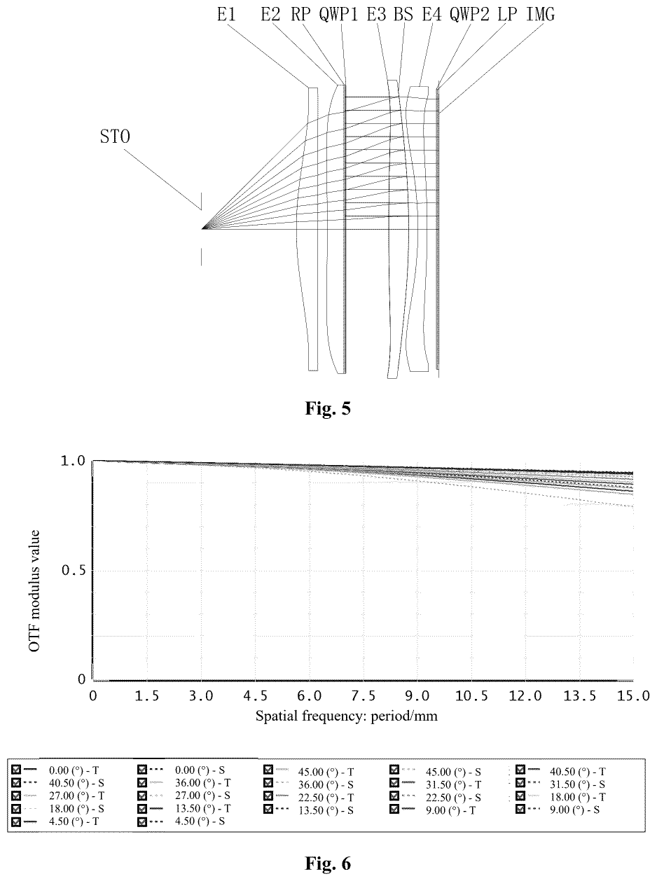

The following describes a visual system according to Embodiment 3 of the disclosure with reference to FIGS. 5-6. FIG. 5 shows a structural schematic diagram of a visual system according to Embodiment 3. FIG. 6 shows a modulation transfer function curve of a visual system according to Embodiment 3, wherein OTF in FIG. 6 refers to optical transfer function.

As shown in FIG. 5, the visual system includes a first lens E1, a second lens E2, a reflective polarizing element RP, a first quarter-wave plate QWP1, a third lens E3, a partially-reflective element BS, a fourth lens E4, a second quarter-wave plate QWP2, and a polarizing filter LP which are arranged in sequence along an optical axis from a first side to a second side. A diaphragm STO is located at an object side of the first lens E1. In the embodiment, the first side refers to a human eye side, and the second side refers to a display screen side.

The first lens E1 has a positive refractive power, a first side surface S1 of the first lens E1 is a convex surface, and a second side surface S2 of the first lens E1 is a concave surface. The second lens E2 has a negative refractive power, a first side surface S3 of the second lens E2 is a concave surface, and a second side surface S4 of the second lens E2 is a planar surface. The third lens E3 has a positive refractive power, a first side surface S5 of the third lens E3 is a convex surface, and a second side surface S6 of the third lens E3 is a convex surface. The fourth lens E4 has a negative refractive power, a first side surface S7 of the fourth lens E4 is a concave surface, and a second side surface S8 of the fourth lens E4 is a convex surface. The reflective polarizing element RP and the first quarter-wave plate QWP1 are attached to the second side surface S4 of the second lens E2. The partially-reflective element BS is attached to the second side surface S6 of the third lens E3. It should be noted that surfaces S1, S2, S3. S4, S5, S6, S7, and S8 are not shown in FIG. 5.

In the embodiment, the second side of the visual system is provided with an imaging surface IMG, which is provided with a display screen. After the image light from the imaging surface IMG sequentially passes through the polarizing filter LP, the second quarter-wave plate QWP2, the fourth lens E4, the third lens E3 and the first quarter-wave plate QWP1, and reaches the reflective polarizing element RP, a first reflection occurs at the reflective polarizing element RP. After the first reflected light passes through the first quarter-wave plate QWP1 and the third lens E3, and reaches the partially-reflective element BS located on the second side surface of the third lens, a second reflection occurs at the partially-reflective element BS. The second reflected light sequentially passes through the third lens E3, the first quarter-wave plate QWP1, the reflective polarizing element RP, the second lens E2 and the first lens E1 to the diaphragm, and is finally projected to the user's eyes. For example, the light rays reflected twice by the visual system are finally projected to the user's eyes.

Table 5 is a basic parameter table of the visual system according to Embodiment 3, wherein the units of radius of curvature and thickness/distance are all millimeters (mm). The image light from the imaging surface IMG passes through the elements in sequence from number 20 to number 1, and is finally projected to the user's eyes.

TABLE 5

| | | | | | Material | | | |
|---|---|---|---|---|---|---|---|---|
| | | Surface | Radius of | Thickness/ | Refractive | Abbe | Refraction/ | Conic |
| Number | Element | type | curvature | distance | index | number | reflection | coefficient |
| | | spherical | infinite | −1300.0000 | | | refraction | |
| 1 | diaphragm | spherical | infinite | 10.0000 | | | refraction | |
| 2 | first lens | aspheric | 31.9239 | 2.2734 | 1.640 | 23.98 | refraction | −10.3250 |
| 3 | | thin | 755.9798 | 0.9916 | | | refraction | 83.4305 |
| | | Fresnel | | | | | | |
| 4 | second lens | aspheric | −320.3534 | 1.7470 | 1.640 | 23.98 | refraction | −98.9941 |
| 5 | reflective | spherical | infinite | 0.1100 | 1.503 | 57.00 | refraction | |
| | polarizing | | | | | | | |
| | element | | | | | | | |
| 6 | first | spherical | infinite | 0.1100 | 1.503 | 57.00 | refraction | |
| | quarter- | | | | | | | |
| | wave plate | | | | | | | |
| 7 | | spherical | infinite | 4.5265 | | | refraction | |
| 8 | third lens | aspheric | 288.9297 | 2.1011 | 1.640 | 23.98 | refraction | 61.7316 |
| 9 | partially- | aspheric | −77.3087 | −2.1011 | 1.640 | 23.98 | reflection | 0.0916 |
| | reflective | | | | | | | |
| | element | | | | | | | |
| 10 | | aspheric | 288.9297 | −4.5265 | | | refraction | 61.7316 |
| 11 | | spherical | infinite | −0.1100 | 1.503 | 57.00 | refraction | |
| 12 | reflective | spherical | infinite | 0.1100 | 1.503 | 57.00 | reflection | |
| | polarizing | | | | | | | |
| | element | | | | | | | |
| 13 | | spherical | infinite | 4.5265 | | | refraction | |
| 14 | third lens | aspheric | 288.9297 | 2.1011 | 1.640 | 23.98 | refraction | 61.7316 |
| 15 | | aspheric | −77.3087 | 0.9880 | | | refraction | 0.0916 |
| 16 | fourth lens | aspheric | −36.6841 | 0.9632 | 1.640 | 23.98 | refraction | 3.1732 |
| 17 | | aspheric | −90.0846 | 0.9777 | | | refraction | −68.8042 |
| 18 | second | spherical | infinite | 0.1100 | 1.503 | 57.00 | refraction | |
| | quarter- | | | | | | | |
| | wave plate | | | | | | | |
| 19 | polarizing | spherical | infinite | 0.1500 | 1.503 | 57.00 | refraction | |
| | filter | | | | | | | |
| 20 | | spherical | infinite | 0.0000 | | | refraction | |
| | imaging | spherical | infinite | 0.0000 | | | refraction | |
| | surface | | | | | | | |

In the embodiment, the first side surface S1 of the first lens E1, the first side surface S3 of the second lens E2, the first side surface S5 and the second side surface S6 of the third lens E3, and the first side surface S7 and the second side surface S8 of the fourth lens E4 are aspheric surfaces, and the second side surface S2 of the first lens E1 is a thin Fresnel surface. Table 6 provides the high-order term coefficients A4, A6. A8, A10, A12, A14, A16, A18 and A20 of the surfaces S1. S2, S3, S5, S6, S7 and S8 applicable to Embodiment 3.

TABLE 6

| Surface | | | | | | | | | |
|---|---|---|---|---|---|---|---|---|---|
| Number | A4 | A6 | A8 | A10 | A12 | A14 | A16 | A18 | A20 |
| S1 | −2.8264E−05 | 1.8674E−08 | −3.4223E−11 | 0.0000E+00 | 0.0000E+00 | 0.0000E+00 | 0.0000E+00 | 0.0000E+00 | 0.0000E+00 |
| S2 | −9.6061E−05 | 1.4036E−07 | −4.0623E−11 | −1.9308E−13 | 9.2555E−17 | 1.5398E−17 | 0.0000E+00 | 0.0000E+00 | 0.0000E+00 |
| S3 | 1.2536E−06 | 1.1023E−07 | 0.0000E+00 | 0.0000E+00 | 0.0000E+00 | 0.0000E+00 | 0.0000E+00 | 0.0000E+00 | 0.0000E+00 |
| S5 | 3.1897E−06 | −5.2846E−08 | 0.0000E+00 | 0.0000E+00 | 0.0000E+00 | 0.0000E+00 | 0.0000E+00 | 0.0000E+00 | 0.0000E+00 |
| S6 | 8.1698E−06 | −7.6172E−09 | 0.0000E+00 | 0.0000E+00 | 0.0000E+00 | 0.0000E+00 | 0.0000E+00 | 0.0000E+00 | 0.0000E+00 |
| S7 | 2.1564E−05 | 1.8132E−07 | 0.0000E+00 | 0.0000E+00 | 0.0000E+00 | 0.0000E+00 | 0.0000E+00 | 0.0000E+00 | 0.0000E+00 |
| S8 | −7.7868E−07 | 1.1827E−07 | 0.0000E+00 | 0.0000E+00 | 0.0000E+00 | 0.0000E+00 | 0.0000E+00 | 0.0000E+00 | 0.0000E+00 |

### Embodiment 4

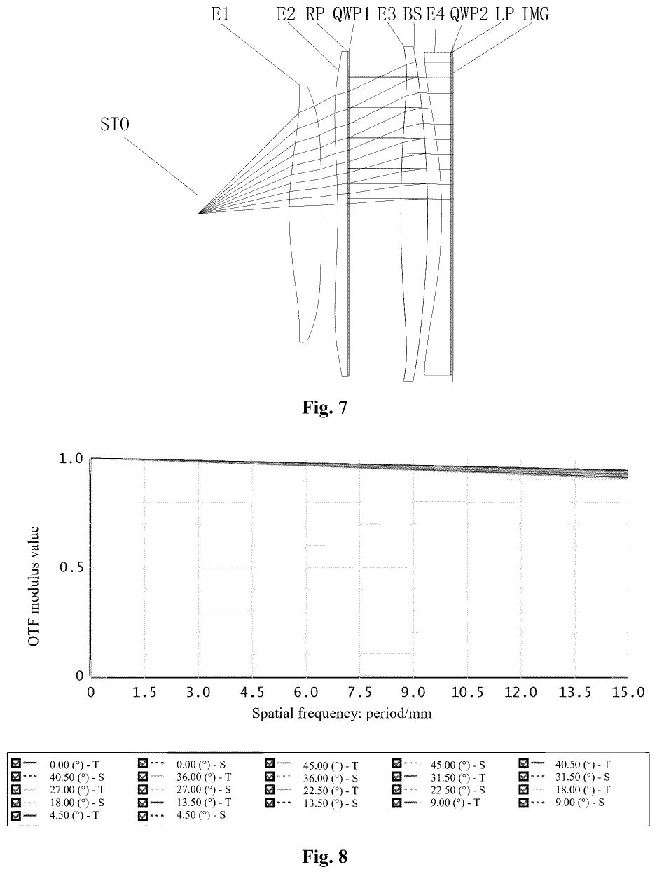

The following describes a visual system according to Embodiment 4 of the disclosure with reference to FIGS. 7-8. FIG. 7 shows a structural schematic diagram of a visual system according to Embodiment 4. FIG. 8 shows a modulation transfer function curve of a visual system according to Embodiment 4, wherein OTF in FIG. 8 refers to optical transfer function.

As shown in FIG. 7, the visual system includes a first lens E1, a second lens E2, a reflective polarizing element RP, a first quarter-wave plate QWP1, a third lens E3, a partially-reflective element BS, a fourth lens E4, a second quarter-wave plate QWP2, and a polarizing filter LP which are arranged in sequence along an optical axis from a first side to a second side. A diaphragm STO is located at an object side of the first lens E1. In the embodiment, the first side refers to a human eye side, and the second side refers to a display screen side.

The first lens E1 has a positive refractive power, a first side surface S1 of the first lens E1 is a convex surface, and a second side surface S2 of the first lens E1 is a concave surface. The second lens E2 has a negative refractive power, a first side surface S3 of the second lens E2 is a concave surface, and a second side surface S4 of the second lens E2 is a planar surface. The third lens E3 has a positive refractive power, a first side surface S5 of the third lens E3 is a convex surface, and a second side surface S6 of the third lens E3 is a convex surface. The fourth lens E4 has a negative refractive power, a first side surface S7 of the fourth lens E4 is a concave surface, and a second side surface S8 of the fourth lens E4 is a planar surface. The reflective polarizing element RP and the first quarter-wave plate QWP1 are attached to the second side surface S4 of the second lens E2. The partially-reflective element BS is attached to the second side surface S6 of the third lens E3. The second quarter-wave plate QWP2 and the polarizing filter LP are attached to the second side surface S8 of the fourth lens E4. It should be noted that surfaces S1, S2, S3, S4, S5, S6, S7, and S8 are not shown in FIG. 7.

In the embodiment, the second side of the visual system is provided with an imaging surface IMG, which is provided with a display screen. After the image light from the imaging surface IMG sequentially passes through the polarizing filter LP, the second quarter-wave plate QWP2, the fourth lens E4, the third lens E3 and the first quarter-wave plate QWP1, and reaches the reflective polarizing element RP, a first reflection occurs at the reflective polarizing element RP. After the first reflected light passes through the first quarter-wave plate QWP1 and the third lens E3, and reaches the partially-reflective element BS located on the second side surface of the third lens, a second reflection occurs at the partially-reflective element BS. The second reflected light sequentially passes through the third lens E3, the first quarter-wave plate QWP1, the reflective polarizing element RP, the second lens E2 and the first lens E1 to the diaphragm, and is finally projected to the user's eyes. For example, the light rays reflected twice by the visual system are finally projected to the user's eyes.

Table 7 is a basic parameter table of the visual system according to Embodiment 4, wherein the units of radius of curvature and thickness/distance are all millimeters (mm). The image light from the imaging surface IMG passes through the elements in sequence from number 19 to number 1, and is finally projected to the user's eyes.

TABLE 7

| | | | | | Material | | | |
|---|---|---|---|---|---|---|---|---|
| | | Surface | Radius of | Thickness/ | Refractive | Abbe | Refraction/ | Conic |
| Number | Element | type | curvature | distance | index | number | reflection | coefficient |
| | | spherical | infinite | −1300.0000 | | | refraction | |
| 1 | diaphragm | spherical | infinite | 10.0000 | | | refraction | |
| 2 | first lens | aspheric | 35.0932 | 3.4901 | 1.640 | 23.98 | refraction | −15.3247 |
| 3 | | aspheric | 578.7352 | 1.8479 | | | refraction | −23.4243 |
| 4 | second lens | aspheric | −76.1476 | 0.9995 | 1.640 | 23.98 | refraction | −98.9995 |
| 5 | reflective | spherical | infinite | 0.1100 | 1.503 | 57.00 | refraction | |
| | polarizing | | | | | | | |
| | element | | | | | | | |
| 6 | first | spherical | infinite | 0.1100 | 1.503 | 57.00 | refraction | |
| | quarter- | | | | | | | |
| | wave plate | | | | | | | |
| 7 | | spherical | infinite | 5.6914 | | | refraction | |
| 8 | third lens | aspheric | 130.5542 | 2.9557 | 1.640 | 23.98 | refraction | −82.4846 |
| 9 | partially- | aspheric | −92.0554 | −2.9557 | 1.640 | 23.98 | reflection | 0.5512 |
| | reflective | | | | | | | |
| | element | | | | | | | |
| 10 | | aspheric | 130.5542 | −5.6914 | | | refraction | −82.4846 |
| 11 | | spherical | infinite | −0.1100 | 1.503 | 57.00 | refraction | |
| 12 | reflective | spherical | infinite | 0.1100 | 1.503 | 57.00 | reflection | |
| | polarizing | | | | | | | |
| | element | | | | | | | |
| 13 | | spherical | infinite | 5.6914 | | | refraction | |
| 14 | third lens | aspheric | 130.5542 | 2.9557 | 1.640 | 23.98 | refraction | −82.4846 |
| 15 | | aspheric | −92.0554 | 1.5419 | | | refraction | 0.5512 |
| 16 | fourth lens | aspheric | −53.2959 | 0.9966 | 1.640 | 23.98 | refraction | 3.9649 |
| 17 | second | spherical | infinite | 0.1100 | | | refraction | |
| | quarter- | | | | | | | |
| | wave plate | | | | | | | |
| 18 | polarizing | spherical | infinite | 0.1500 | 1.503 | 57.00 | refraction | |
| | filter | | | | | | | |
| 19 | | aspheric | infinite | 0.0000 | 1.503 | 57.00 | refraction | |
| | imaging | spherical | infinite | 0.0000 | | | refraction | |
| | surface | | | | | | | |

In the embodiment, the first side surface S1 and the second side surface S2 of the first lens E1, the first side surface S3 of the second lens E2, the first side surface S5 and the second side surface S6 of the third lens E3, and the first side surface S7 of the fourth lens E4 are aspheric surfaces. Table 8 provides the high-order term coefficients A4, A6, A8, A10, A12, A14. A16, A18 and A20 of the surfaces S1, S2. S3, 85, S6 and S7 applicable to Embodiment 4.

TABLE 8

| Surface | | | | | | | | | |
|---|---|---|---|---|---|---|---|---|---|
| Number | A4 | A6 | A8 | A10 | A12 | A14 | A16 | A18 | A20 |
| S1 | −1.7511E−05 | −2.8763E−08 | 2.1281E−11 | 0.0000E+00 | 0.0000E+00 | 0.0000E+00 | 0.0000E+00 | 0.0000E+00 | 0.0000E+00 |
| S2 | −4.0260E−05 | −1.9348E−08 | 0.0000E+00 | 0.0000E+00 | 0.0000E+00 | 0.0000E+00 | 0.0000E+00 | 0.0000E+00 | 0.0000E+00 |
| S3 | 1.5711E−05 | 8.4221E−09 | 0.0000E+00 | 0.0000E+00 | 0.0000E+00 | 0.0000E+00 | 0.0000E+00 | 0.0000E+00 | 0.0000E+00 |
| S5 | 7.1364E−06 | −3.8487E−08 | 0.0000E+00 | 0.0000E+00 | 0.0000E+00 | 0.0000E+00 | 0.0000E+00 | 0.0000E+00 | 0.0000E+00 |
| S6 | 6.4462E−06 | −1.2089E−08 | 0.0000E+00 | 0.0000E+00 | 0.0000E+00 | 0.0000E+00 | 0.0000E+00 | 0.0000E+00 | 0.0000E+00 |
| S7 | 7.2068E−06 | 2.8910E−08 | 0.0000E+00 | 0.0000E+00 | 0.0000E+00 | 0.0000E+00 | 0.0000E+00 | 0.0000E+00 | 0.0000E+00 |

### Embodiment 5

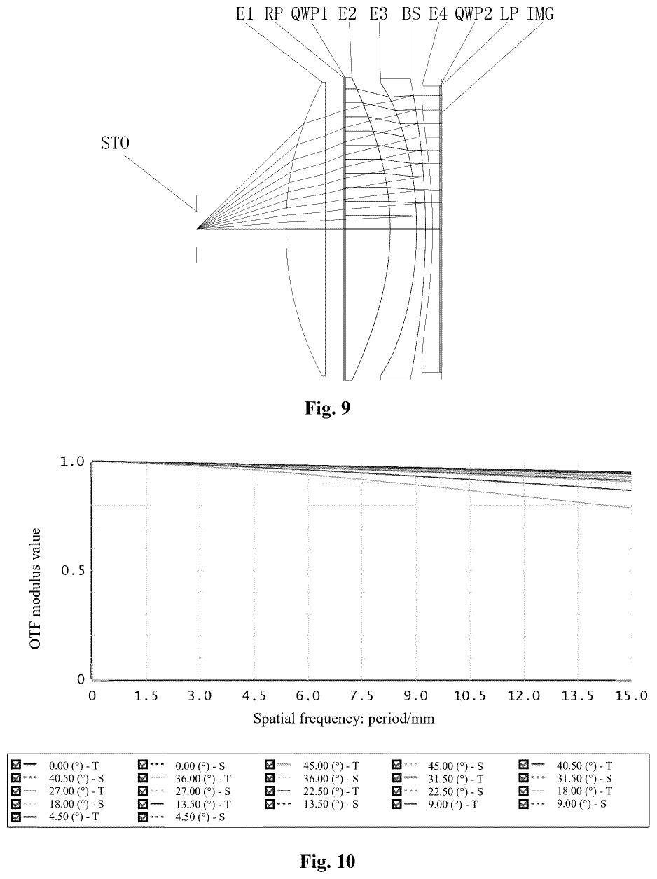

The following describes a visual system according to Embodiment 5 of the disclosure with reference to FIGS. 9-10. FIG. 9 shows a structural schematic diagram of a visual system according to Embodiment 5. FIG. 10 shows a modulation transfer function curve of a visual system according to Embodiment 5, wherein OTF in FIG. 10 refers to optical transfer function.

As shown in FIG. 9, the visual system includes a first lens E1, a reflective polarizing element RP, a first quarter-wave plate QWP1, a second lens E2, a third lens E3, a partially-reflective element BS, a fourth lens E4, a second quarter-wave plate QWP2, and a polarizing filter LP which are arranged in sequence along an optical axis from a first side to a second side. A diaphragm STO is located at an object side of the first lens E1. In the embodiment, the first side refers to a human eye side, and the second side refers to a display screen side.

The first lens E1 has a positive refractive power, a first side surface S1 of the first lens E1 is a convex surface, and a second side surface S2 of the first lens E1 is a convex surface.

The second lens E2 has a positive refractive power, a first side surface S3 of the second lens E2 is a planar surface, and a second side surface S4 of the second lens E2 is a convex surface. The third lens E3 has a negative refractive power, a first side surface S5 of the third lens E3 is a concave surface, and a second side surface S6 of the third lens E3 is a convex surface. The fourth lens E4 has a negative refractive power, a first side surface S7 of the fourth lens E4 is a concave surface, and a second side surface S8 of the fourth lens E4 is a planar surface. The reflective polarizing element RP and the first quarter-wave plate QWP1 are attached to the first side surface S3 of the second lens E2. The partially-reflective element BS is attached to the second side surface S6 of the third lens E3. The second quarter-wave plate QWP2 and the polarizing filter LP are attached to the second side surface S8 of the fourth lens E4. It should be noted that surfaces S1, S2, S3, S4, S5, S6, S7, and S8 are not shown in FIG. 9.

In the embodiment, the second side of the visual system is provided with an imaging surface IMG, which is provided with a display screen. After the image light from the imaging surface IMG sequentially passes through the polarizing filter LP, the second quarter-wave plate QWP2, the fourth lens E4, the third lens E3, the second lens E2 and the first quarter-wave plate QWP1, and reaches the reflective polarizing element RP, a first reflection occurs at the reflective polarizing element RP. After the first reflected light passes through the first quarter-wave plate QWP1, the second lens E2 and the third lens E3, and reaches the partially-reflective element BS located on the second side surface of the third lens, a second reflection occurs at the partially-reflective element BS. The second reflected light sequentially passes through the third lens E3, the second lens E2, the first quarter-wave plate QWP1, the reflective polarizing element RP and the first lens E1 to the diaphragm, and is finally projected to the user's eyes. For example, the light rays reflected twice by the visual system are finally projected to the user's eyes.

Table 9 is a basic parameter table of the visual system according to Embodiment 5, wherein the units of radius of curvature and thickness/distance are all millimeters (mm). The image light from the imaging surface IMG passes through the elements in sequence from number 21 to number 1, and is finally projected to the user's eyes.

TABLE 9

| | | | | | Material | | | |
|---|---|---|---|---|---|---|---|---|
| | | Surface | Radius of | Thickness/ | Refractive | Abbe | Refraction/ | Conic |
| Number | Element | type | curvature | distance | index | number | reflection | coefficient |
| | | spherical | infinite | −1300.0000 | | | refraction | |
| 1 | diaphragm | spherical | infinite | 10.0000 | | | refraction | |
| 2 | first lens | aspheric | 37.6175 | 4.4370 | 1.527 | 52.12 | refraction | −22.7737 |
| 3 | | thin | −168.3680 | 2.0281 | | | refraction | 99.0000 |
| | | Fresnel | | | | | | |
| 4 | reflective | spherical | infinite | 0.1100 | 1.503 | 57.00 | refraction | |
| | polarizing | | | | | | | |
| | element | | | | | | | |
| 5 | first | spherical | infinite | 0.1100 | 1.503 | 57.00 | refraction | |
| | quarter- | | | | | | | |
| | wave plate | | | | | | | |
| 6 | second lens | spherical | infinite | 5.0329 | 1.547 | 70.13 | refraction | |
| 7 | | aspheric | −30.6653 | 2.9648 | | | refraction | −2.8185 |
| 8 | third lens | aspheric | −39.5949 | 0.9912 | 1.661 | 21.52 | refraction | 3.1284 |
| 9 | partially- | aspheric | −81.0820 | −0.9912 | 1.661 | 21.52 | reflection | 3.0517 |
| | reflective | | | | | | | |
| | element | | | | | | | |
| 10 | | aspheric | −39.5949 | −2.9648 | | | refraction | 3.1284 |
| 11 | | aspheric | −30.6653 | −5.0329 | 1.547 | 70.13 | refraction | −2.8185 |
| 12 | | spherical | infinite | −0.1100 | 1.503 | 57.00 | refraction | |
| 13 | reflective | spherical | infinite | 0.1100 | 1.503 | 57.00 | reflection | |
| | polarizing | | | | | | | |
| | element | | | | | | | |
| 14 | second lens | spherical | infinite | 5.0329 | 1.547 | 70.13 | refraction | |
| 15 | | aspheric | −30.6653 | 2.9648 | | | refraction | −2.8185 |
| 16 | third lens | aspheric | −39.5949 | 0.9912 | 1.661 | 21.52 | refraction | 3.1284 |
| 17 | | aspheric | −81.0820 | 0.7918 | | | refraction | 3.0517 |
| 18 | fourth lens | aspheric | −65.0641 | 0.7840 | 1.641 | 23.42 | refraction | 5.7468 |
| 19 | second | spherical | infinite | 0.1100 | 1.503 | 57.00 | refraction | |
| | quarter- | | | | | | | |
| | wave plate | | | | | | | |
| 20 | polarizing | spherical | infinite | 0.1500 | 1.503 | 57.00 | refraction | |
| | filter | | | | | | | |
| 21 | | spherical | infinite | 0.0000 | | | refraction | |
| | imaging | spherical | infinite | 0.0000 | | | refraction | |
| | surface | | | | | | | |

In the embodiment, the first side surface S1 of the first lens E1, the second side surface S4 of the second lens E2, the first side surface S5 and the second side surface S6 of the third lens E3, and the first side surface S7 of the fourth lens E4 are aspheric surfaces, and the second side surface S2 of the first lens E1 is a thin Fresnel surface. Table 10 provides the high-order term coefficients A4, A6, A8, A10, A12, A14, A16, A18 and A20 of the surfaces S1, S2, S4, S5, 86 and S7 applicable to Embodiment 5.

TABLE 10

| Surface | | | | | | | | | |
|---|---|---|---|---|---|---|---|---|---|
| Number | A4 | A6 | A8 | A10 | A12 | A14 | A16 | A18 | A20 |
| S1 | 5.5695E−05 | −2.5404E−07 | 7.0704E−10 | −7.2962E−13 | 0.0000E+00 | 0.0000E+00 | 0.0000E+00 | 0.0000E+00 | 0.0000E+00 |
| S2 | −3.3652E−06 | 4.9964E−08 | −5.8858E−10 | 1.4678E−12 | 0.0000E+00 | 0.0000E+00 | 0.0000E+00 | 0.0000E+00 | 0.0000E+00 |
| S4 | 0.0000E+00 | 0.0000E+00 | 0.0000E+00 | 0.0000E+00 | 0.0000E+00 | 0.0000E+00 | 0.0000E+00 | 0.0000E+00 | 0.0000E+00 |
| S5 | 1.0551E−05 | −1.1516E−08 | 0.0000E+00 | 0.0000E+00 | 0.0000E+00 | 0.0000E+00 | 0.0000E+00 | 0.0000E+00 | 0.0000E+00 |
| S6 | 2.3009E−06 | 6.8515E−10 | 0.0000E+00 | 0.0000E+00 | 0.0000E+00 | 0.0000E+00 | 0.0000E+00 | 0.0000E+00 | 0.0000E+00 |
| S7 | 4.3216E−06 | 4.5400E−08 | 0.0000E+00 | 0.0000E+00 | 0.0000E+00 | 0.0000E+00 | 0.0000E+00 | 0.0000E+00 | 0.0000E+00 |

### Embodiment 6

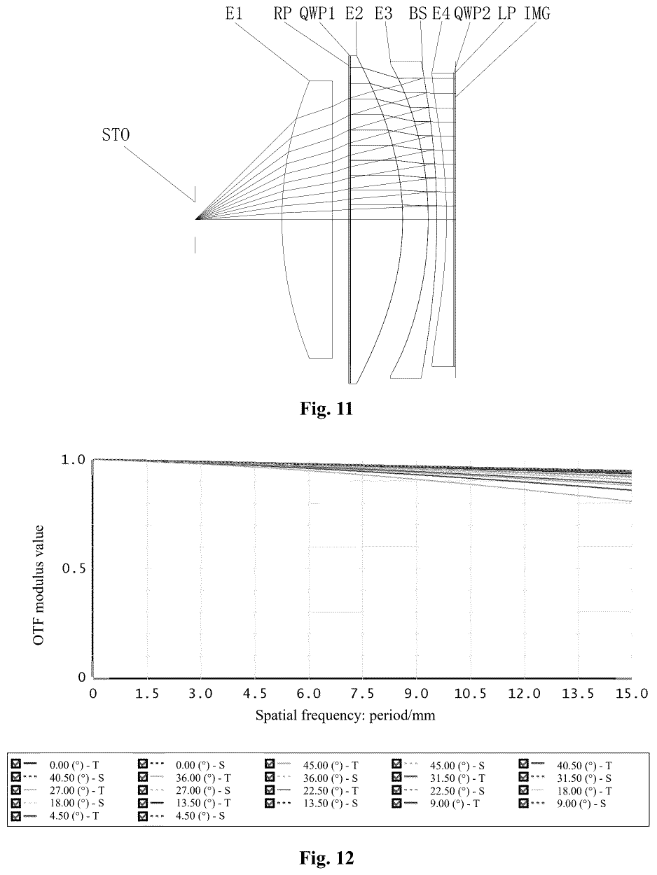

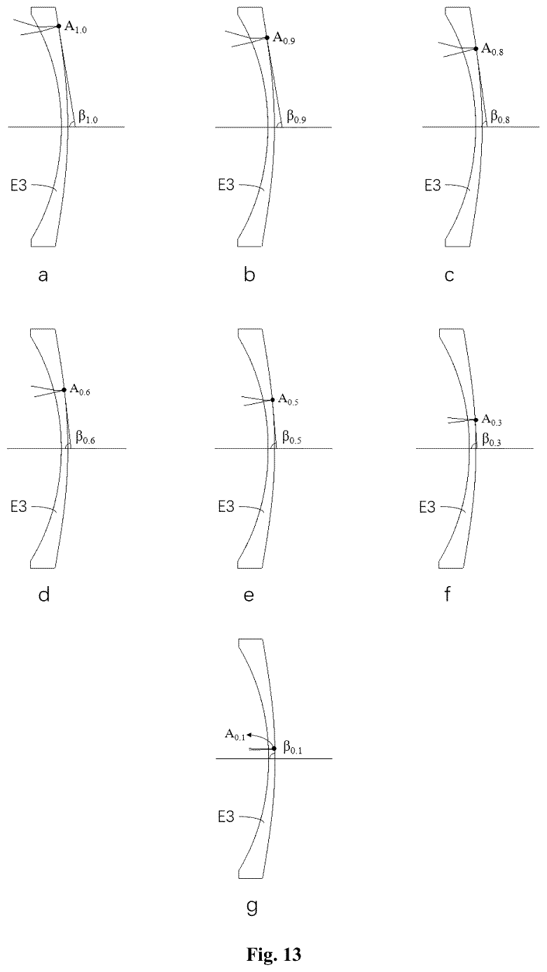

The following describes a visual system according to Embodiment 6 of the disclosure with reference to FIGS. 11-12. FIG. 11 shows a structural schematic diagram of a visual system according to Embodiment 6. FIG. 12 shows a modulation transfer function curve of a visual system according to Embodiment 6, wherein OTF in FIG. 12 refers to optical transfer function.

As shown in FIG. 11, the visual system includes a first lens E1, a reflective polarizing element RP, a first quarter-wave plate QWP1, a second lens E2, a third lens E3, a partially-reflective element BS, a fourth lens E4, a second quarter-wave plate QWP2, and a polarizing filter LP which are arranged in sequence along an optical axis from a first side to a second side. A diaphragm STO is located at an object side of the first lens E1. In the embodiment, the first side refers to a human eye side, and the second side refers to a display screen side.

The first lens E1 has a positive refractive power, a first side surface S1 of the first lens E1 is a convex surface, and a second side surface S2 of the first lens E1 is a convex surface. The second lens E2 has a positive refractive power, a first side surface S3 of the second lens E2 is a planar surface, and a second side surface S4 of the second lens E2 is a convex surface. The third lens E3 has a negative refractive power, a first side surface S5 of the third lens E3 is a concave surface, and a second side surface S6 of the third lens E3 is a convex surface. The fourth lens E4 has a negative refractive power, a first side surface S7 of the fourth lens E4 is a concave surface, and a second side surface S8 of the fourth lens E4 is a planar surface. The reflective polarizing element RP and the first quarter-wave plate QWP1 are attached to the first side surface S3 of the second lens E2. The partially-reflective element BS is attached to the second side surface S6 of the third lens E3. The second quarter-wave plate QWP2 and the polarizing filter LP are attached to the second side surface S8 of the fourth lens E4. It should be noted that surfaces S1, S2, S3, S4, S5, S6, S7, and S8 are not shown in FIG. 11.

In the embodiment, the second side of the visual system is provided with an imaging surface IMG, which is provided with a display screen. After the image light from the imaging surface IMG sequentially passes through the polarizing filter LP, the second quarter-wave plate QWP2, the fourth lens E4, the third lens E3, the second lens E2 and the first quarter-wave plate QWP1, and reaches the reflective polarizing element RP, a first reflection occurs at the reflective polarizing element RP. After the first reflected light passes through the first quarter-wave plate QWP1, the second lens E2 and the third lens E3, and reaches the partially-reflective element BS located on the second side surface of the third lens, a second reflection occurs at the partially-reflective element BS. The second reflected light sequentially passes through the third lens E3, the second lens E2, the first quarter-wave plate QWP1, the reflective polarizing element RP and the first lens E1 to the diaphragm, and is finally projected to the user's eyes. For example, the light rays reflected twice by the visual system are finally projected to the user's eyes.

Table 11 is a basic parameter table of the visual system according to Embodiment 6, wherein the units of radius of curvature and thickness/distance are all millimeters (mm). The image light from the imaging surface IMG passes through the elements in sequence from number 21 to number 1, and is finally projected to the user's eyes.

TABLE 11

| | | | | | Material | | | |
|---|---|---|---|---|---|---|---|---|
| | | Surface | Radius of | Thickness/ | Refractive | Abbe | Refraction/ | Conic |
| Number | Element | type | curvature | distance | index | number | reflection | coefficient |
| | | spherical | infinite | −1300.0000 | | | refraction | |
| 1 | diaphragm | spherical | infinite | 10.0000 | | | refraction | |
| 2 | first lens | aspheric | 41.4492 | 5.8061 | 1.538 | 55.87 | refraction | 0.6989 |
| 3 | | thin | −868.1480 | 1.8792 | | | refraction | 94.5126 |
| | | Fresnel | | | | | | |
| 4 | reflective | spherical | infinite | 0.1100 | 1.503 | 57.00 | refraction | |
| | polarizing | | | | | | | |
| | element | | | | | | | |
| 5 | first | spherical | infinite | 0.1100 | 1.503 | 57.00 | refraction | |
| | quarter- | | | | | | | |
| | wave plate | | | | | | | |
| 6 | second lens | spherical | infinite | 6.0011 | 1.547 | 70.13 | refraction | |
| 7 | | aspheric | −30.9016 | 2.9495 | | | refraction | −2.1483 |
| 8 | third lens | aspheric | −40.7505 | 0.9879 | 1.645 | 23.78 | refraction | −8.4564 |
| 9 | partially- | aspheric | −85.8058 | −0.9879 | 1.645 | 23.78 | reflection | 3.8307 |
| | reflective | | | | | | | |
| | element | | | | | | | |
| 10 | | aspheric | −40.7505 | −2.9495 | | | refraction | −8.4564 |
| 11 | | aspheric | −30.9016 | −6.0011 | 1.547 | 70.13 | refraction | −2.1483 |
| 12 | | spherical | infinite | −0.1100 | 1.503 | 57.00 | refraction | |
| 13 | reflective | spherical | infinite | 0.1100 | 1.503 | 57.00 | reflection | |
| | polarizing | | | | | | | |
| | element | | | | | | | |
| 14 | second lens | spherical | infinite | 6.0011 | 1.547 | 70.13 | refraction | |
| 15 | | aspheric | −30.9016 | 2.9495 | | | refraction | −2.1483 |
| 16 | third lens | aspheric | −40.7505 | 0.9879 | 1.645 | 23.78 | refraction | −8.4564 |
| 17 | | aspheric | −85.8058 | 1.1103 | | | refraction | 3.8307 |
| 18 | fourth lens | aspheric | −63.9063 | 0.7892 | 1.645 | 23.78 | refraction | 4.7937 |
| 19 | second | spherical | infinite | 0.1100 | 1.503 | 57.00 | refraction | |
| | quarter- | | | | | | | |
| | wave plate | | | | | | | |
| 20 | polarizing | spherical | infinite | 0.1500 | 1.503 | 57.00 | refraction | |
| | filter | | | | | | | |
| 21 | | spherical | infinite | 0.0000 | | | refraction | |
| | imaging | spherical | infinite | 0.0000 | | | refraction | |
| | surface | | | | | | | |

In the embodiment, the first side surface S1 of the first lens E1, the second side surface S4 of the second lens E2, the first side surface S5 and the second side surface S6 of the third lens E3, and the first side surface S7 of the fourth lens E4 are aspheric surfaces, and the second side surface S2 of the first lens E1 is a thin Fresnel surface. Table 12 provides the high-order term coefficients A4, A6, A8, A10, A12, A14, A16, A18 and A20 of the surfaces S1, S2, S4, S5, S6 and S7 applicable to Embodiment 6.

TABLE 12

| Surface | | | | | | | | | |
|---|---|---|---|---|---|---|---|---|---|
| Number | A4 | A6 | A8 | A10 | A12 | A14 | A16 | A18 | A20 |
| S1 | −1.4482E−06 | −1.3705E−08 | 8.0634E−11 | −1.4173E−13 | 0.0000E+00 | 0.0000E+00 | 0.0000E+00 | 0.0000E+00 | 0.0000E+00 |
| S2 | −8.0448E−06 | −6.3277E−10 | 1.4079E−12 | 0.0000E+00 | 0.0000E+00 | 0.0000E+00 | 0.0000E+00 | 0.0000E+00 | 0.0000E+00 |
| S4 | 1.0626E−06 | −1.0563E−08 | 1.8843E−11 | 0.0000E+00 | 0.0000E+00 | 0.0000E+00 | 0.0000E+00 | 0.0000E+00 | 0.0000E+00 |
| S5 | −1.2222E−05 | 4.7479E−09 | −1.2787E−11 | 0.0000E+00 | 0.0000E+00 | 0.0000E+00 | 0.0000E+00 | 0.0000E+00 | 0.0000E+00 |
| S6 | 1.6958E−06 | 2.1092E−09 | 6.8434E−13 | 0.0000E+00 | 0.0000E+00 | 0.0000E+00 | 0.0000E+00 | 0.0000E+00 | 0.0000E+00 |
| S7 | 4.8535E−06 | 1.6296E−08 | 1.0454E−11 | 0.0000E+00 | 0.0000E+00 | 0.0000E+00 | 0.0000E+00 | 0.0000E+00 | 0.0000E+00 |

Table 13 provides the basic parameters in each of Embodiments 1 to 6, such as the values of f, f1, f2, f3, f4, fz, CTR, CTQ1, CTQ2, CTL, TD, β_{1.0}, β_{0.9}, β_{0.6}, β_{0.8}, β_{0.5}, β_{0.3} and β_{0.1}.

TABLE 13

| Parameter/ | | | | | | |
|---|---|---|---|---|---|---|
| Embodiment | 1 | 2 | 3 | 4 | 5 | 6 |
| f(mm) | 17.66 | 17.23 | 17.66 | 20.49 | 18.95 | 20.37 |
| f1(mm) | 76.65 | 200.63 | 51.98 | 58.19 | 58.81 | 73.65 |
| f2(mm) | 47.59 | 49.07 | −500.21 | −118.90 | 56.06 | 56.50 |
| f3(mm) | −100.96 | 170.32 | 95.44 | 84.74 | −118.12 | −121.42 |
| f4(mm) | −86.44 | −170.65 | −97.31 | −83.22 | −101.47 | −99.12 |
| fz(mm) | 47.59 | 49.07 | −500.21 | −118.90 | 56.06 | 56.50 |
| CTR(mm) | 0.11 | 0.11 | 0.11 | 0.11 | 0.11 | 0.11 |
| CTQ1(mm) | 0.11 | 0.11 | 0.11 | 0.11 | 0.11 | 0.11 |
| CTQ2(mm) | 0.11 | 0.11 | 0.11 | 0.11 | 0.11 | 0.11 |
| CTL(mm) | 0.15 | 0.15 | 0.15 | 0.15 | 0.15 | 0.15 |
| TD(mm) | 14.85 | 13.93 | 13.81 | 17.74 | 17.25 | 19.74 |
| β_{1.0}(°) | 80.84 | 82.25 | 83.19 | 80.94 | 80.52 | 80.70 |
| β_{0.9}(°) | 81.25 | 82.41 | 83.47 | 82.36 | 81.30 | 81.28 |
| β_{0.8}(°) | 81.86 | 82.76 | 83.80 | 83.36 | 82.11 | 82.01 |
| β_{0.6}(°) | 83.58 | 83.95 | 84.76 | 84.83 | 83.90 | 83.76 |
| β_{0.5}(°) | 84.60 | 84.75 | 85.41 | 85.51 | 84.86 | 84.74 |
| β_{0.3}(°) | 86.75 | 86.67 | 87.03 | 87.09 | 86.86 | 86.80 |
| β_{0.1}(°) | 88.92 | 88.86 | 88.97 | 88.99 | 88.95 | 88.93 |

Table 14 provides the values of the conditional expression in each of Embodiments 1 to 6.

TABLE 14

| Conditional | | | | | | |
|---|---|---|---|---|---|---|
| expression/ | | | | | | |
| Embodiment | 1 | 2 | 3 | 4 | 5 | 6 |
| β_{1.0} | 80.84 | 82.25 | 83.19 | 80.94 | 80.52 | 80.70 |
| β_{0.8} | 81.86 | 82.76 | 83.80 | 83.36 | 82.11 | 82.01 |
| R6 | −73.53 | −68.26 | −77.31 | −92.06 | −81.08 | −85.81 |
| f3/fz | −2.12 | 3.47 | −0.19 | −0.71 | −2.11 | −2.15 |
| CT4/ | 3.31 | 3.46 | 3.70 | 3.83 | 3.02 | 3.04 |
| (CTQ2 + CTL) | | | | | | |
| R1/f | 1.95 | 3.66 | 1.81 | 1.71 | 1.99 | 2.03 |
| f4/f1 | −1.13 | −0.85 | −1.87 | −1.43 | −1.73 | −1.35 |
| tan(β_{0.3})/ | 0.33 | 0.34 | 0.35 | 0.35 | 0.34 | 0.33 |
| tan(β_{0.1}) | | | | | | |
| β_{0.5} + | 168.17 | 168.70 | 170.16 | 170.34 | 168.75 | 168.50 |
| β_{0.6} | | | | | | |
| f×(N3/N1) | 18.76 | 17.23 | 17.66 | 20.49 | 20.62 | 21.78 |
| TD/\|f4\| | 0.17 | 0.08 | 0.14 | 0.21 | 0.17 | 0.20 |
| (CTR + | 0.19 | 0.23 | 0.22 | 0.12 | 0.10 | 0.10 |
| CTQ1)/T12 | | | | | | |
| β_{0.9} | 81.25 | 82.41 | 83.47 | 82.36 | 81.30 | 81.28 |
| Vmin | 23.98 | 23.98 | 23.98 | 23.98 | 21.52 | 23.78 |
| R7/R6 | 0.76 | 1.51 | 0.47 | 0.58 | 0.80 | 0.74 |

The disclosure further provides an optical apparatus. The optical apparatus is an independent projection device such as a projector, and is also a projection module integrated on a mobile electronic device such as a virtual reality device. The optical apparatus is equipped with the visual system described above.

The above description is only the specific embodiments of the disclosure and the illustration of the technical principles applied thereto. A person skilled in the art should understand that the scope of the invention involved in the disclosure is not limited to the technical solutions formed by the specific combination of the described technical features, and should also cover other technical solutions formed by any combination of the described technical features or equivalent features thereof without departing from the concept of the invention. For example, the described features and technical features having similar functions disclosed in the disclosure (but not limited thereto) may be replaced with each other to form a technical solution.

What is claimed is:

1. A visual system, sequentially comprising from a first side to a second side along an optical axis:
a first lens with a positive refractive power, wherein a first side surface thereof is a convex surface;
a second lens with a positive or negative refractive power;
a third lens with a positive or negative refractive power, wherein a second side surface thereof is a convex surface;
a partially-reflective element, wherein the partially-reflective element is located on the second side surface of the third lens;
a fourth lens with a negative refractive power, wherein a first side surface thereof is a concave surface;
a second quarter-wave plate; and
a polarizing filter;
wherein the visual system comprises four lenses with refractive powers;
the visual system further comprises a reflective polarizing element and a first quarter-wave plate which are arranged in sequence from the first side to the second side and attached to each other, the first quarter-wave plate is located on a first side surface of the second lens, or the reflective polarizing element is located on a second side surface of the second lens;
the visual system satisfies: 80.5°<β_{1.0}<83.2° and 81.85°<β_{0.8}<83.85°,
where β_{1.0} is an included angle between the optical axis and a tangent of the second side surface of the third lens at a position of an intersection point of a chief ray in a 1.0 field of view after being reflected by the partially-reflective element and the second side surface of the third lens, and β_{0.8} is an included angle between the optical axis and a tangent of the second side surface of the third lens at a position of an intersection point of a chief ray in a 0.8 field of view after being reflected by the partially-reflective element and the second side surface of the third lens.

2. The visual system according to claim 1, wherein the visual system further satisfies:
$$- 92.1 mm < R 6 < - 6 8.25 mm ,$$
where R6 is a radius of curvature of the second side surface of the third lens.

3. The visual system according to claim 1, wherein the visual system further satisfies:
$$- 2 \text{.2} < f 3 / fz < 3.5 ,$$
where f3 is an effective focal length of the third lens, and fz is a combined focal length of the second lens, the reflective polarizing element and the first quarter-wave plate.

4. The visual system according to claim 1, wherein the visual system further satisfies:
$$3. < CT 4 / ( CTQ 2 + CTL ) < 3.85 ,$$
where CT4 is a center thickness of the fourth lens on the optical axis, CTQ2 is a center thickness of the second quarter-wave plate on the optical axis, and CTL is a center thickness of the polarizing filter on the optical axis.

5. The visual system according to claim 1, wherein the visual system further satisfies:
$$1.7 < R 1 / f < 3.7 ,$$
where R1 is a radius of curvature of the first side surface of the first lens, and f is a total effective focal length of the visual system.

6. The visual system according to claim 1, wherein the visual system further satisfies:
$$- 1.9 < f 4 / f 1 < - 0.8 ,$$
where f4 is an effective focal length of the fourth lens, and f1 is an effective focal length of the first lens.

7. The visual system according to claim 1, wherein the visual system further satisfies:
$$0.3 < tan ( {β}_{0.3} ) / tan ( {β}_{0.1} ) < 0.4 ,$$
where β_{0.3} is an included angle between the optical axis and a tangent of the second side surface of the third lens at a position of an intersection point of a chief ray in a 0.3 field of view after being reflected by the partially-reflective element and the second side surface of the third lens, and β_{0.1} is an included angle between the optical axis and a tangent of the second side surface of the third lens at a position of an intersection point of a chief ray in a 0.1 field of view after being reflected by the partially-reflective element and the second side surface of the third lens.

8. The visual system according to claim 1, wherein the visual system further satisfies:
$$168.15 ° < {β}_{0.5} + {β}_{0.6} < 170.35 ° ,$$
where β_{0.5} is an included angle between the optical axis and a tangent of the second side surface of the third lens at a position of an intersection point of a chief ray in a 0.5 field of view after being reflected by the partially-reflective element and the second side surface of the third lens, and β_{0.6} is an included angle between the optical axis and a tangent of the second side surface of the third lens at a position of an intersection point of a chief ray in a 0.6 field of view after being reflected by the partially-reflective element and the second side surface of the third lens.

9. The visual system according to claim 1, wherein the visual system further satisfies:
$$17.2 mm < f \times ( N 3 / N 1 ) < 21.8 mm ,$$
where f is a total effective focal length of the visual system, N1 is a refractive index of the first lens, and N3 is a refractive index of the third lens.

10. The visual system according to claim 1, wherein the visual system further satisfies:
$$0.05 < TD / \vert f 4 \vert < 0.25 ,$$
where TD is an on-axis distance from the first side surface of the first lens to a second side surface of the fourth lens, and f4 is an effective focal length of the fourth lens.

11. The visual system according to claim 1, wherein the visual system further satisfies:
$$0 \text{.08} < ( CTR + CTQ 1 ) / T 12 < 0.25 ,$$
where T12 is an on-axis distance from a second side surface of the first lens to the first side surface of the second lens, CTR is a center thickness of the reflective polarizing element on the optical axis, and CTQ1 is a center thickness of the first quarter-wave plate on the optical axis.

12. The visual system according to claim 1, wherein the visual system further satisfies:
$$81.2 ° < {β}_{0.9} < 83.5 ° ,$$
where β_{0.9} is an included angle between the optical axis and a tangent of the second side surface of the third lens at a position of an intersection point of a chief ray in a 0.9 field of view after being reflected by the partially-reflective element and the second side surface of the third lens.

13. The visual system according to claim 1, wherein the visual system further satisfies:
$$21.5 < V min < 24. ,$$
where Vmin is an Abbe number of a lens with a minimum Abbe number among the first lens to the fourth lens.

14. The visual s stem according to claim 1, wherein the visual system further satisfies:
$$0.45 < R 7 / R 6 < 1.55 \text{?} .$$
$$\text{?} \text{indicates text missing or illegible when filed}$$
where R6 is a radius of curvature of the second side surface of the third lens, and R7 is a radius of curvature of the first side surface of the fourth lens.
